(19) United States
(12) Patent Application Publication
(10) Pub. No.: US 2011/0276642 A1
(43) Pub. Date: Nov. 10, 2011

(54) Platform Independent Interactive Dialog-Based Electronic Learning Environments

(75) Inventors: Dimitri Gioev, Sherman Oaks, CA (US); Diana Katsman, Sherman Oaks, CA (US)

(73) Assignee: EXELERA, LLC, Sherman Oaks, CA (US)

(21) Appl. No.: 13/100,633

(22) Filed: May 4, 2011

Related U.S. Application Data
(60) Provisional application No. 61/331,780, filed on May 5, 2010.

(51) Int. Cl. G06F 15/16

(52) U.S. Cl. 709/206

(57) ABSTRACT

Among other things, techniques, apparatus, systems and non-transitory computer-readable medium are disclosed for implementing interactive text-based dialogs. In one aspect, a method performed by a server device can include receiving, at the server device, a request to initiate a text-based dialog session from a user operating at a client device. The user can be authenticated. Additionally, a text-based message can be received from the user requesting a response from the server device. A reply text based message can be delivered to the user, and the contents of the reply text based message can be obtained based on a context of the text based message from the user.

### CROSS REFERENCE TO RELATED APPLICATIONS

This application claims the benefit of the priority of U.S. Provisional Application Ser. No. 61/331,780, filed May 5, 2010, and entitled “Platform Independent Interactive Dialog-Based Learning Environments”.

### BACKGROUND

This application relates to electronic learning technologies.

Remote or electronic learning technologies often require each user to install a client device or communication channel specific user-side application. Once installed, the user-side application is used to provide knowledge to the user. For example, an applet can be installed on the user's web browser to allow the user to interact with a particular web site. In another example, software can be installed on a user device to provide only those knowledge contained within the software. Often, the required user-side application can be too large to be installed on a mobile device and thus, the user's ability to obtain knowledge is limited by a stationary computer.

### SUMMARY

Techniques and structures and apparatus are disclosed for implementing a platform independent, interactive dialog-based electronic learning system.

The subject matter described in this specification potentially can provide one or more of the following advantages. For example, providing knowledge dissemination and delivery using small chunks of information in a course of light-weight student-system dialogs can prevent a student from facing an overwhelming amount of material contained in a physical textbook. By having the system reply immediately but allowing the student to decide when to resume the educational dialog, a student can feel in control of the learning process. The described techniques, apparatus and system uses short-message communication, which is familiar to young students and is a widely accepted and enjoyed way of communication. The text based student-system dialogs are mobile-enabled and can be carried out seamlessly over standard communication channels including: cellular phone text messaging (e.g., SMS, Short Message Service, etc.), automated email, and input via a text form at a website operated by a server.

### BRIEF DESCRIPTION OF THE DRAWINGS

FIG. 1 is a block diagram showing a server-side system for providing a platform independent interactive dialog-based learning tools or environments to multiple users.

FIG. 2 is a block diagram showing an example communication between the user/client device and a server-side system.

FIG. 3 is a block diagram showing an example of data communication between a server-side system and different client/user devices.

FIG. 4 is a block diagram showing the different types of data stored at the server-side system.

FIG. 5 shows a block diagram of implementing an SMS connector.

FIGS. 6A, 6B and 6C show a sequence of images that illustrate a user operating the same dialog session using two different client devices.

FIGS. 7A, 7B, 7C, 7D, 7E and 7F show a sequence of images that illustrate various operations and functions available to a user during a dialog session.

Like reference symbols and designations in the various drawings indicate like elements.

### DETAILED DESCRIPTION

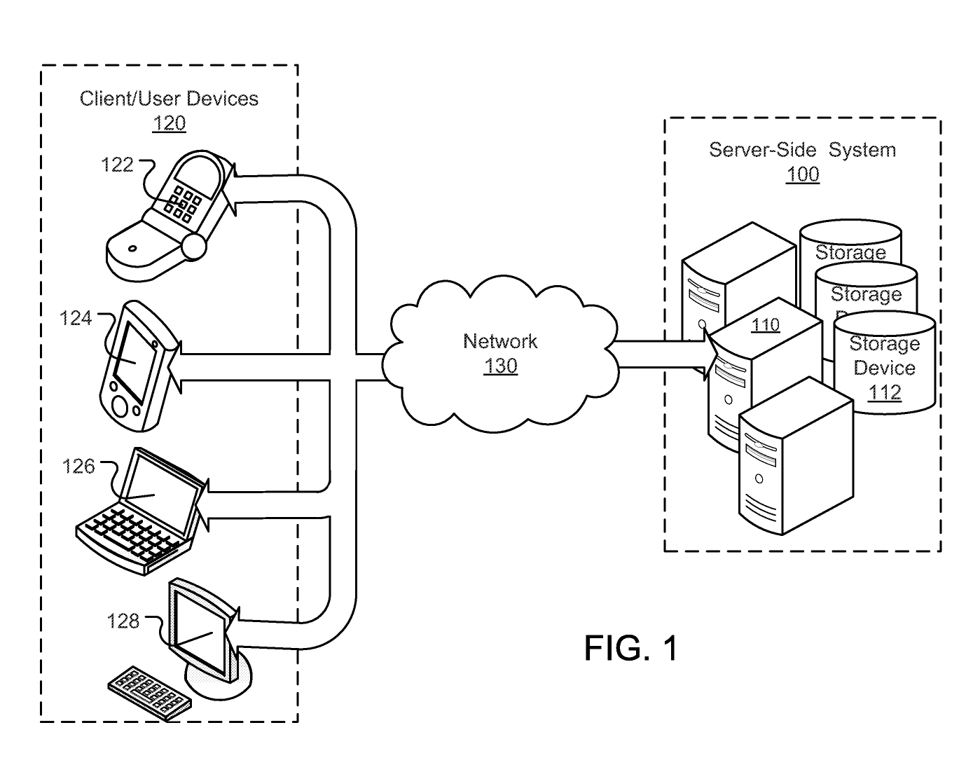

The techniques, structures and apparatus described in this application can be used to implement an Interactive Dialog-Based Learning System. FIG. 1 is a block diagram showing a server-side system 100 for providing a platform independent interactive dialog-based learning tools or environments to multiple users. The server-side system 100 can be designed to provide a game-like teaching/practice system (GTPS) that disseminates and delivers knowledge by means of small chunks of information in the course of light-weight student-system dialogs. The server-side system 100 can communicate with multiple client devices 120 over a network 130 to implement the light-weight student-system dialogs. The server-side system 100 can include various computing devices, such as server computers 110 for performing the functions of the platform independent interactive dialog-based learning tools and storage devices 112 to store data associated with the platform independent interactive dialog-based learning tools. These functions and data are described further below.

The student-system dialogs are text-based and mobile-enabled, which can be carried out seamlessly over the network 130 that includes multiple channels including: (1) cellular phone text messaging, such as Short Message Service (SMS), (2) automated email, and (3) input via a text form at a website operated by the server-side system 100. Thus, the network 130 can include both cellular networks and data networks, such as the Internet. Additional standard communication channels, such as Instant Messaging (IM), chat, and voice channels can be added to the system. The dialogs can have a light-weight and game-like feel, in particular, to allow the user/student's input to be very short (e.g., can be limited to a single letter), whereas the system replies can be detailed and can have longer data-length (e.g., can be up to 160 symbols in length, which is the standard size of an SMS message).

The server-side system 100 can communicate with various client/user devices, such as a mobile phone 122 (including smartphones), a personal digital assistant (PDA) 124, a portable computer 126 and a desktop computer 128. Moreover, the server-side system 100 is platform independent because the system is not limited to one type of client device, operating system, etc. Moreover, the student-system interaction is seamless over the available text based channels. For example, the student may start solving a problem via the SMS channel, continue via the Email channel, and finish via the Website. Each time the student switches to a new channel, the student-system communication is picked up from exactly the same location in the dialog session that the previous channel left off. In switching between the channels, the user can switch between different client/user devices 120. For example, a user can initiate an interactive dialog-based learning session starting on one type of user device (e.g., mobile phone), then continue the session on a different device (e.g., a desktop computer). The server-side system 100 is able to provide the interactive dialog-based learning tools independent of the user/client device because the system is not locked into a particular client/user device but rather on a user account. The platform independence of the server-side system 100 can be implemented by eliminating the need to provide a clients-side application. All of the processing and functionalities involved in providing the interactive dialog-based learning tools are performed at the server-side system 100. Because the client/user device need not install a client-side application, the system can provide a light-weight implementation and be independent of the user/client devices.

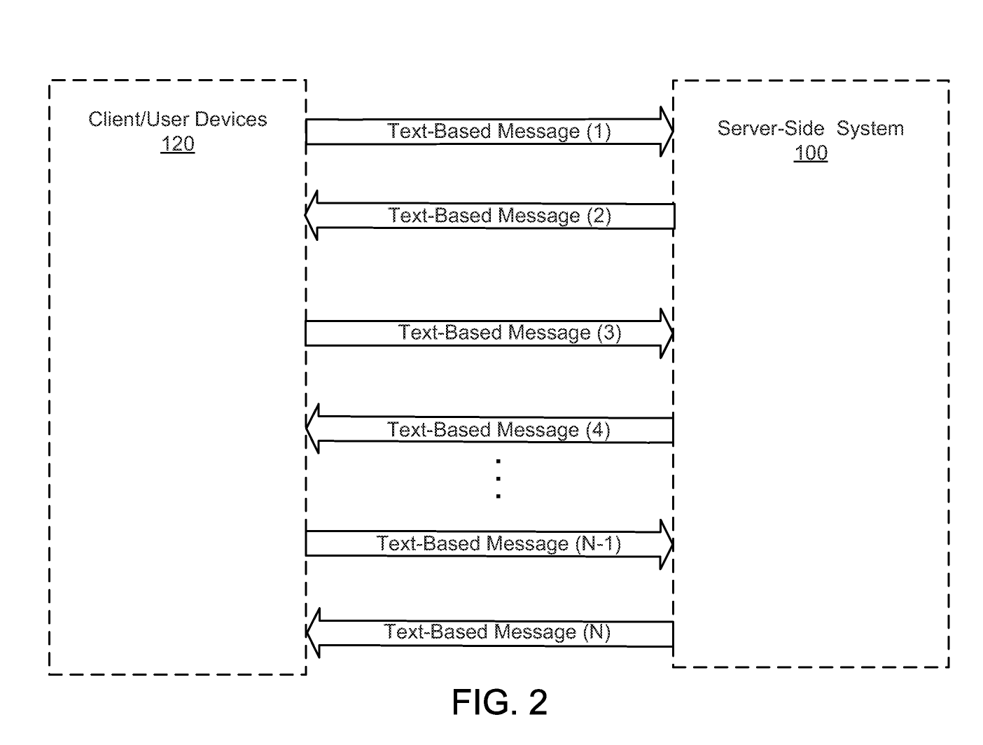

As described above and further below, the system is interactive and dialog-based, which uses text-based dialog technologies such as IM, SMS, email, etc. to disseminate and deliver knowledge to the users. To maintain a light-weight system, short educational dialogs can be implemented to assist and enable the learning process by distributing knowledge in small chunks; the content can be both class theory and practice/problems, for example. Using the small chunks idea, knowledge dissemination can be performed one text-based message at a time, for example. FIG. 2 is a block diagram showing an example communication between the user/client device 120 and the server-side system 100. For example, the client/user device 120 can send a message (text-based message (1)) to the server-side system 100. Responsive to the received text-based message (1), the servers-side system 100 can deliver knowledge (e.g., requested information) to the user/client device 120 in a text-based message (e.g., text-based message (2)). In such manner, a dialog is created between the client/user device 120 and the server-side system 100. Each pair of text-based messages can constitute a dialog between the client/user device 120 and the server-side system 100. For illustrative purposes, N text-based messages that represent N/2 dialogs are shown. There is no limit to the total number of dialogs as the user can continue the session until logging out.

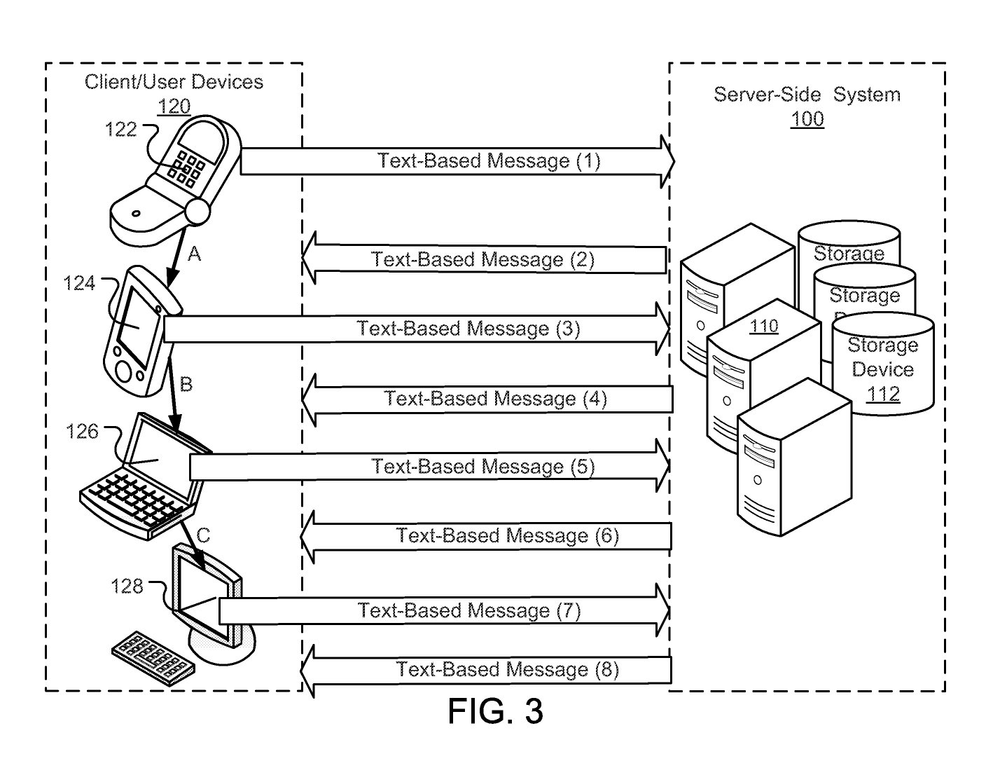

FIG. 3 is a block diagram showing an example of data communication between the server-side system 100 and different client/user devices 120. As describe above, the interactive dialog-based learning tools provided by the server-side system 100 are independent of the client/server devices 120. This can be accomplished because the system 100 does not rely on any client-side applications. Thus, a user can begin a learning session on one client device and continue the session on different devices. Moreover, because of the client/user device independence, the user can even use client/user devices that belong to other users. For example, the user can initiate a dialog by sending a text-based message (e.g., text-based message (1)) from a mobile device 122 using text messaging. Responsive to the text-based message (1), the serve-side system 100 can deliver data or knowledge to the user using a text-based message (e.g., text-based message (2)). Because the knowledge is delivered to the user (e.g., user account), rather than to a particular client/user device, the user can receive the knowledge at any client device 120. For example, the user can move on to a PDA 124, access the knowledge delivered by the server-side system 100 and send another text-based message (e.g., text-based message (3)) from the PDA 124. Responsive to the text-based message (3) from the PDA 124, the sever-side system 100 can send more data/knowledge to the user using another text-based message (e.g., using text-based message (4)). The user can continue to move to another client/user device, such as a portable computer 126 to send the next text-based message (e.g., text-based message (5)) in the same session. Responsive to the text-based message (5), the server-side system 100 can deliver more information/knowledge to the user (e.g., in another text-based message (6)). The user can yet again move on to another client/user device, such as a desktop computer 128 to send yet another text-based message (e.g., text-based message (7) in the same session. Responsive to the text-based message (7), the server-side system 100 can deliver more information/knowledge using another text-based message (e.g., text-based message (8). Thus, the user can continue with the same session across unlimited number of different user/client devices 120. The arrows A, B and C represent the user moving from one client/user device to another.

An example structure of an elementary course part, a problem, contains the problem statement, one or several related theory excerpts, one or several hints, solution, and answer. Example 1 below provides a detailed example of a Review Class:

### Example 1

### Sample GTPS Course that Includes Sections with Problems in Various Subjects Illustrating the Versatility and Broad Applicability of the Suggested System

A class Select Subject Review was created in GTPS associated with school Demonstration School by Teacher1. The class creation was carried out via a plain text file upload via the GTPS website gamelike.net in the following format. The class contains 7 Chapters in the subjects of Mathematics, Physics, Chemistry, Biology, Medicine, Military Theory, and Language. All of the Chapters contain one Section. Every Section contains one problem except for the Section in the Physics Chapter which contains two problems.
In order to add a chapter number 1, a section number 1.1, and a problem number 1.1.1 to a given class, the following lines are included in the plain text upload file:

| | |
|---|---|
| 1 | Chapter_Name |
| 1.1 | Section_Name |
| 1.1.1. | |
| PROBLEM | Problem_Statement |
| THEORY | Problem_Theory_Exerpt |
| HINT | Problem_Hint |
| SOLUTION | Problem_Solution |
| ANSWER | Problem_Answer |
| ANSWER_TYPE | Problem_Answer_Verification_Method |

The Actual Upload Textbook File for the Demonstration Course follows.

| | |
|---|---|
| 1 | Mathematics Review |
| 1.1 | Arithmetic and Algebra |
| 1.1.1 | |
| PROBLEM | Simplify: 12/27 = ? |
| THEORY | A number can be factorized: written as a product of smaller |
| | numbers |
| HINT | Factorize 12 and 27 and cancel out equal factors |
| SOLUTION | 12/27 = (3 * 4)/(3 * 9) = 4/9 |
| ANSWER | 4/9 |
| ANSWER_TYPE | STRING (exact match verification) |
| 2 | Physics Review |
| 2.1 | Electricity |
| 2.1.1 | |
| PROBLEM | A potential of 2 V is applied between two points resulting in a |
| | current of 0.05 A. What is the resistance in Ohm? |
| THEORY | Potential = Current * Resistance, V = I * R (Ohm's Law) |
| HINT | Submit a number or a numeric expression |
| SOLUTION | R = V/I = 2 V/0.05 A = 40 Ohm |
| ANSWER | 40 |
| ANSWER_TYPE | FLOAT (number or numeric expression) |
| 2 | Physics Review |
| 2.1 | Electricity |
| 2.1.2 | |
| PROBLEM | Two resistors of resistance R1 and R2 are connected in parallel. |
| | What is the resulting resistance? |
| THEORY | For resistors connected in parallel, the resulting inverse resistance |
| | is a sum of their inverse resistances |
| HINT | Submit the resulting formula in terms of R1 and R2 |
| SOLUTION | 1/R = 1/R1 + 1/R2, hence R = R1 * R2/(R1 + R2) |
| ANSWER | R1 * R2/(R1 + R2) |
| ANSWER_TYPE | FLOAT (symbolic expression evaluated as a floating number) |
| 3 | Chemistry Review |
| 3.1 | Inorganic Chemistry |
| 3.1.1 | |
| PROBLEM | Two products result from neutralization of HCl with NaOH. One is |
| | the water H2O, what is the other one? |
| THEORY | Neutralization is the reaction between an acid and a base |
| | producing a salt and the water |
| HINT | Write the equation HCl + NaOH->? + H20 and count quantities of the |
| | elements |
| SOLUTION | HCl + NaOH -> NaCl + H20 |
| ANSWER | NaCl |
| ANSWER_TYPE | STRING (exact match) |
| 4 | Biology Review /*multiple choice example*/ |
| 4.1 | Higher Organisms |
| 3.1.1 | |
| PROBLEM | Mammals' circulatory system is: 1-open, complete; 2-closed, |
| | complete; 3-open, incomplete; 4-closed, incomplete |
| THEORY | Closed: blood is pumped by a heart through vessels (does not fill |
| | body cavities). Complete: the heart is completely separated into two |
| | pumps. |
| HINT | Can blood in mammals fill body cavities? Are the two circulations |
| | completely separated in the heart? |
| SOLUTION | 2 |
| ANSWER | 2 |
| ANSWER_TYPE | STRING (exact match) |
| 5 | Medicine Review |
| 5.1 | Endocrinology |
| 5.1.1 | |
| PROBLEM | Send any three initial diabetes symptoms (separated by commas) |
| THEORY | Diabetes, Type I: autoimmune destruction of the insulin producing |
| | beta cells of the pancreas; Type II: hyperglycemia due to insulin |
| | resistance |
| HINT | Symptoms are caused by high glucose concentration in blood |
| | (hyperglycemia) |
| SOLUTION | Excessive thirst, excessive urination, weight loss, excessive |
| | hunger, extreme fatigue, lack of energy |
| ANSWER | Excessive thirst, excessive urination, weight loss, excessive |
| | hunger, extreme fatigue, lack of energy |
| ANSWER_TYPE | SET OF STRINGS (must all be in the answer set; their number is at |
| | least three) |
| 6 | Military Review |
| 6.1 | Modern U.S. Armor Tactics |
| 6.1.1 | |
| PROBLEM | A tank platoon leader suddenly balls his right fist and starts |
| | punching to his right. What does this mean? |
| THEORY | Action right is a maneuver where all the tanks turn to the right and |
| | attack an enemy on line. |
| HINT | The answer is one of the following: contact right, action right, |
| | echelon right. |
| SOLUTION | Action right is a maneuver where all the tanks turn to the right and |
| | attack an enemy on line. |
| ANSWER | action right |
| ANSWER_TYPE | STRING (exact match) |
| 7 | English Language Review |
| 7.1 | Present Perfect Tense |
| 7.1.1 | |
| PROBLEM | Fill in the correct form of the verb “to see”: “I have already . . . this |
| | movie.” |
| THEORY | Present Perfect Tense: have/has + 3rd form of the verb. |
| HINT | “To see” is an irregular verb. |
| SOLUTION | seen |
| ANSWER | seen |
| ANSWER_TYPE | STRING (exact match) |

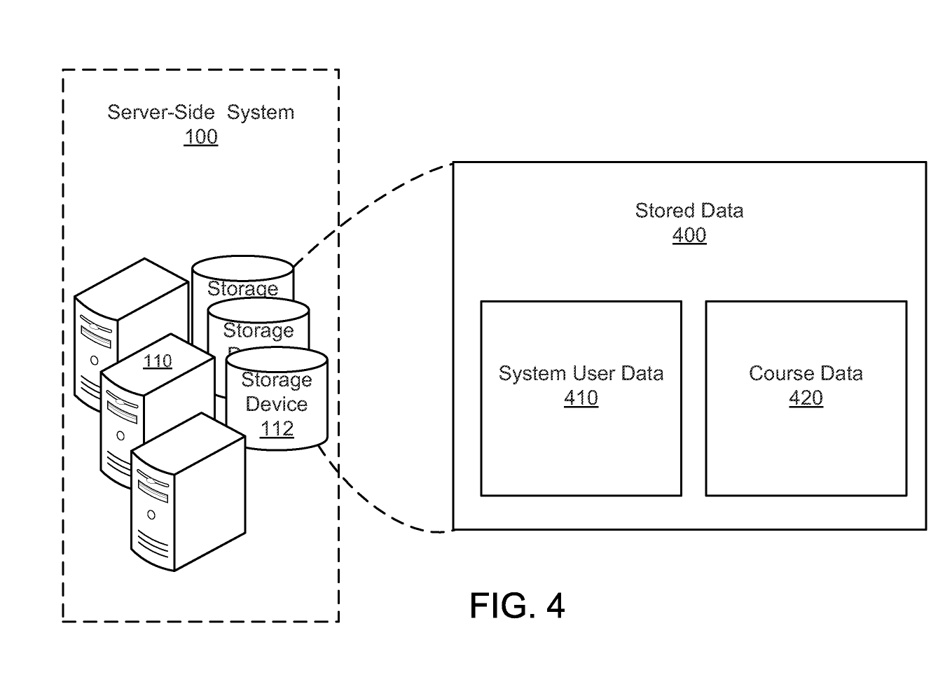

FIG. 4 is a block diagram showing the different types of data stored at the server-side system 100. The data 400 that the server-side system 100 stores and uses can be organized into two groups: the data on the system users 410 and the data on the courses 420 loaded into the system. Examples of data structure hierarchy for the user data 410 and the course data 420 are shown below.

### 0.1. GTPS Users Hierarchy

GTPS

SCHOOL

SCHOOL ADMINISTRATOR
TEACHER
STUDENT

### 0.2. GTPS Course/Textbook Hierarchy

The overall database hierarchy is as follows:

GTPS

SCHOOL

CLASS/TEXTBOOK

CHAPTER

SECTION

PROBLEM

The user can navigate along the hierarchy of the user data 410 and the course data 420 by sending an appropriate text-based message to the server-side system 100. Responsive to the text-based message received from the user and the location of the user along the hierarchy, the server-side system 100 can deliver the appropriate corresponding information/knowledge to the user.

In the example shown above, the basic object used in the education process facilitated by the system is PROBLEM. The object, PROBLEM, in turn, can include a number of fields as described below.

| | |
|---|---|
| Basic object: | Example: |

| | |
|---|---|
| PROBLEM | Problem 1.3.8: |

| | |
|---|---|
| PROBLEM STATEMENT | Simplify: 12/27 = ? |
| THEORY EXCERPT | A number can be |
| | factorized: written as a |
| | product of smaller |
| | numbers. |
| HINT | Factorize 12 and 27 and |
| | cancel out equal |
| | factors. |
| SOLUTION/EXPLANATION | 12/27 = (3 * 4)/(3 * 9) = 4/9 |
| ANSWER | 4/9 |

The user can send a simple (e.g., one letter) text-based message that requests any of the fields described on the left-hand column, and responsive to the text-based message, the server-side system can provide the information associated with the requested field. For example, the user can send a text-based message ‘H’ for ‘HINT’ and the server-side system 100 can deliver a text-based message ‘Factorize 12 and 27 and cancel out equal factors’ to the user in response.

A problem can have multiple theory excerpts and hints associated with it. Those can be sent to the user sequentially if the user requests more help from the server-side system 100.

The database structures, their interconnections, system commands, and algorithms pertaining to the user request queuing and processing are described further below. In one aspect, a remote database control/updating/navigation using short mobile-enabled commands can be performed (see Example 2 below for an extended educational dialog; the back end processing of every command in the dialog by GTPS involves database read/write operations at the GTPS server).

### Example 2

### An Extended Student-System SMS Dialog Carried Out Using the Proof-of-Concept GTPS (as Included in the Form of Screenshots in a Different Document) Illustrating all of the Main Features of GTPS

| User | |
|---|---|
| Input | GTPS Response |
| GTPS ? | Commands: Info: I, L [chap[.sect]]. Position: C [class], F, B, W |
| | [chap[.sect[.prob]]]. Problem: P, T, H, S, A, or expression. Visit |
| | gamelike.net for details. |
| I | Welcome Dimitri Gioev. You are a student at Demonstration |
| | School. Send C for your classes or ? for commands. |
| C | Current class: Math Grade 6. To change send C number with |
| | number = 1 for Math Grade 6, 2 for Phys Grade |
| | 6, 3 for Select Subject Review. |
| C3 | Current class was set to: Select Subject Review. |
| L | Current class contains 7 chapters, 7 sections, 8 problems. Send L |
| | number for chapter info where number = 1 2 3 4 5 6 7 |
| L2 | Chapter 2: Physics Review contains 1 section, 2 problems. |
| | Send L 2.number for section info where |
| | number = 1 |
| GTPS | Section 2.1: Electricity contains 2 problems. Problem numbers: |
| L2.1 | 1 2. Use commands F, B, W to navigate |
| | between problems. |
| GTPS | Current location: Problem 1.1.1 (Chap 1, Sect 1, Prob 1). |
| W | Send W chap.sect.prob, W chap.sect, W chap to |
| | change location. Related commands: L and C. |
| GTPS | Current problem is set to Problem 2.1.1. Use commands |
| W2.1 | P, T, H, S, A to work with this problem. Use |
| | commands F, B, W to change current problem. |
| P | Problem 2.1.1. Formulation: A potential of 2V between two |
| | points results in a current of 0.05 A. What is the |
| | resistance in Ohm? |
| T | Problem 2.1.1. Theory: Potential = Current * Resistance, or |
| | symbolically V = I * R (Ohm's Law) |
| H | Problem 2.1.1. Hint: Submit a number or a numeric expression |
| GTPS | Problem 2.1.1: Well done! Your answer 2/0.05 is correct. |
| 2/0.05 | |
| B | Problem 1.1.1. Formulation: Simplify: 12/27 = ? |
| T | Problem 1.1.1. Theory: A number can be factorized: written as a |
| | product of smaller numbers |
| H | Problem 1.1.1. Hint: Factorize 12 and 27 and cancel out |
| | equal factors |
| S | Problem 1.1.1. Solution: 12/27 = (3 * 4)/(3 * 9) = 4/9 |
| R | Progress report (solved/total): Problem 1.1.1: 0/1. Section |
| | 1.1: 0/1. Chapter 1: 0/1. Current Class: 0/8. Log on to |
| | gamelike.net for detailed progress reports. |

Workflow for Adding a New Client (School)

Table 1 below describes a data base structure for users and adding new users.

TABLE 1
Adding New Users

| | Performer's Authority | |
|---|---|---|
| Step | in System | Detailed Description |
| 1 | GTPS Administrator | Create a new School profile: School1 |
| | | Create a new Administrator profile for |
| | | School1: Administrator1 |
| 2 | School Administrator | Create a new Teacher profile for |
| | | School1: Teacher1 Create new Student |
| | | profile for School1: Student1 |
| 3 | School Teacher | Create a new Class profile: Class1 |
| | | Create a new Textbook profile: |
| | | Textbook1 Connect Students with |
| | | Class1 |
| 4 | School Student | Can modify own password, email, cell |
| | | phone, voice phone |

Database Interconnections: School, Class, Teacher, Student

For a school learning environment example, the database structure and interconnection methods between a school, a class, a teacher and the students can be standardized. Assume that there is one Administrator (Admin1), two Teachers (Teacher1 and Teacher2), and five Students (Student1 . . . Student5) in School1.

Table 2 below describes a database structure for maintaining user information. The main information for Administrator(s), Teacher(s), and Student(s) is given in the database table below. User Type is 0 for a student, 1 for a teacher, and 2 for a school administrator.

TABLE 2
User_Info

| User | First | Last | | | | Cell Phone | User |
|---|---|---|---|---|---|---|---|
| ID | Name | Name | Login | Password | Email | (for SMS access) | Type |
| 10 | John | Berg | Admin1 | ******** | Admin1@ | 12223334454 | 2 |
| | | | | | school1.edu | | |
| 11 | Gregg | Parker | Teacher1 | ******** | Teacher1@ | 12223334455 | 1 |
| | | | | | school1.edu | | |
| 11 | Anna | Lewis | Teacher2 | ******** | Teacher2@ | 12223334458 | 1 |
| | | | | | school1.edu | | |
| 1 | Laura | Anderson | Student1 | ******** | Student1@ | 12223334457 | 0 |
| | | | | | school1.edu | | |
| 3 | Sarah | DeVico | Student3 | ******** | Student3@ | 12223334458 | |
| | | | | | school1.edu | | |
| 2 | Alex | Morris | Student2 | ******** | Student2@ | 12223334460 | 0 |
| | | | | | school1.edu | | |
| 4 | Ed | Brenner | Student4 | ******** | Student4@ | 12223334481 | 0 |
| | | | | | school1.edu | | |

Table 3 below describes a database structure for maintaining association between the school and the administrator(s) teachers and students.

TABLE 3
School_to-User

| | | User Privilege | Comment (not in |
|---|---|---|---|
| School ID | User ID | Code | database) |
| 1 | 10 | 2 | Administrator |
| 1 | 11 | 1 | Teacher |
| 1 | 12 | 1 | Teacher |
| 1 | 1 | 0 | Student |
| . . . | . . . | . . . | |
| 1 | 4 | 0 | Student |

Next, for simple illustration, assume that three classes are offered in School1: Class1, Class2, and Class3. Assume that Teacher1 is associated with Class1 and Class2; and Teacher2 is associated with Class2 and Class3 (i.e., Class2 is taught jointly by two teachers). Also, assume that: Student1 takes Class1; Student2 takes Class 1 and Class2; Student3 takes Class3; Student4 takes Class2 and Class3; Student5 takes all three classes. Then the basic database interconnection tables can be as shown in Tables 4 and 5 below:

TABLE 4
School_to-Class

| School ID | Class ID |
|---|---|
| 1 | 1 |
| 1 | 2 |
| 1 | 3 |

TABLE 5
Class_to-Student

| Class ID | Student ID |
|---|---|
| 1 | 1 |
| 1 | 2 |
| 1 | 5 |
| 2 | 2 |
| 2 | 4 |
| 2 | 5 |
| 3 | 3 |
| 3 | 4 |
| 3 | 5 |

Database Interconnections: Textbook/Problem, Student's Current Position, and Student Progress

The following describes the Textbook/Problem Data Structures. For illustrative purposes, the Textbook and Problem data structures for Class1 are described below. The server-side system 100 does not require the entire set of Chapters. Sections, and Problems to be included in the Class information. In addition, the enumeration of Chapters, Sections, and Problems is flexible as explained below. This feature can be useful, for example, if odd-numbered problems are solved in class, and even-numbered are left for the homework. Then the even-numbered problems will be included in server-side system 100.

Assume that the Teacher decided to include only part of the Class1 Textbook chapters for use in GTPS. Three chapters are to be included: Chapter1, Chapter4, and Chapter5. Table 6 shows examples of book chapter names.

TABLE 6
Chapter_Names

| ClassID | Chapter | Name |
|---|---|---|
| 1 | 1 | Arithmetic Operations |
| 1 | 4 | Calculating Percentages |
| 1 | 5 | Areas of Square, Rectangle, and Triangle |

Assume that the Teacher decided to include the following Sections into GTPS:

In Chapter1, two sections are included: Section2 and Section4.

In Chapter4, three sections are included: Section1, Section2, and Section5.

In Chapter5, one section is included: Section8.

Table 7 shows examples of section names.

TABLE 7
Section_Names

| ClassID | Chapter | Section | Name |
|---|---|---|---|
| 1 | 1 | 2 | Integer Numbers |
| 1 | 1 | 4 | Fractional Numbers |
| 1 | 4 | 1 | Definition of Percentage |
| 1 | 4 | 2 | First Examples |
| 1 | 4 | 5 | Additional Training |
| 1 | 5 | 8 | Triangles of General Shapes |

Assume that three problems are included in Section1 of Chapter1: Problem2, Problem3, and Problem5. Let one problem be included for Section5 of Chapter4: Problem1. Assume that two problems are included in each of the remaining Sections for all of the remaining Chapters, and that their numbers are 2 and 7. That information is stored in the following Table of Contents (TOC) database structure.

TABLE 8
Textbook_TOC

| Class ID | Chapter | Section | Problem | ProblemID |
|---|---|---|---|---|
| 1 | 1 | 2 | 2 | 1 |
| 1 | 1 | 2 | 3 | 2 |
| 1 | 1 | 2 | 5 | 3 |
| 1 | 1 | 4 | 2 | 4 |
| 1 | 1 | 4 | 7 | 5 |
| 1 | 4 | 1 | 2 | 6 |
| 1 | 4 | 1 | 7 | 7 |
| 1 | 4 | 2 | 2 | 8 |
| 1 | 4 | 2 | 7 | 9 |
| 1 | 4 | 5 | 1 | 11 |
| 1 | 5 | 8 | 2 | 12 |
| 1 | 5 | 8 | 7 | 13 |

The ProblemID column above need not be ordered, and it contains the unique problem identifiers from Table 9: Problem_Info below, that can change as the problems are deleted and added. Two database structures are associated with the Textbook: one holds the names of chapters and sections (textbook Table of Contents), and the other contains the assignments.

In order to optimize the database usage, the Formulation, Theory Excerpt, Hint, Solution, Answer for each Problem can be saved in a separate table Problem_Info. The unique Problem ID for each Problem from Problem_Info is then connected with the table that holds the Problem number in the format Chapter.Section.Problem.

For each problem, several Theory Excepts and several Hints can be stored; the next theory excerpt/hint will be sent to the student if (s)he requests theory excerpt/hint several times. This supports the “disseminating knowledge in small pieces” approach on which the server-side system is based.

TABLE 9
Problem_Info

| ProblemID | Formulation | Theory | Hint | Solution | Answer | AnswerType |
|---|---|---|---|---|---|---|
| 1 | Calculate: | Adding two | Lay 2 and 2 | 2 + 2 = 4 | 4 | 0 |
| | 2 + 2 = ? | numbers is | more sticks | | | |
| | | the same as | on the table. | | | |
| | | counting. | Count them from | | | |
| | | | the first one. | | | |
| 4 | Simplify: | A number can | Write 12 and 27 | 12/27 = | 4/9 | 1 |
| | 12/27 = ? | be written as | as products of | (3*4)/(3*9) = | | |
| | | a product | smaller numbers | 4/9 | | |
| | | of smaller | and cancel out | | | |
| | | numbers. | the same | | | |
| | | | numbers. | | | |
| 12 | Two resistors | For resistors | Submit the | 1/R = 1/R1 + | R1*R2/ | 0 |
| | of resistance | connected in | resulting | 1/R2, hence | (R1 + R2) | |
| | R1 and R2 | parallel, the | mathematical | R = R1*R2/ | | |
| | are connected | resulting | formula in | (R1 + R2) | | |
| | in parallel. | inverse | terms of R1 | | | |
| | What is the | resistance | and R2 | | | |
| | resulting | is a sum of | | | | |
| | resistance? | their inverse | | | | |
| | | resistances | | | | |

While possible to do so, for brevity, Table 9 above does not include the records for other Problems.

Answer Format and Verification Method of Student's Attempted Answer by the Server-Side System

The server-side system 100 supports verification of student's input against the stored Answer in a variety of formats. Consequently, the database structure Problem_Info supports Answer storing in several formats as shown in Table 10 below:

TABLE 10
Answer format and verification method of student's attempted answer by
Server-Side System

| AnswerType | | |
|---|---|---|
| Code | Answer Type | Examples |
| 0 | a floating point number, | In Problem 1 above, 4 is the correct |
| | or expression without | answer. |
| | variables that evaluates | In Problem 12 above: the two expressions |
| | to a floating point | below will be graded by GTPS as a correct |
| | number, or | answer since they lead to the same |
| | a symbolic mathematical | mathematical formula that depends on R1 |
| | expression that contains | and R2: |
| | variables, e.g., | R1 * R2/(R1 + R2), or |
| | R1 * R2/(R1 + R2) | 1/(1/R1 + 1/R2) |
| 1 | a string of characters (a | For example, in Problem 2 above: the |
| | word), or | correct answer is the string of characters |
| | one character (suitable | “4/9”, but not “12/27” or “24/54” that |
| | for multiple choice | evaluate to the same number, but do not |
| | problems) | represent a result of the required |
| | | simplification |
| 2 | a set of comma- | For example the ANSWER can be |
| | separated words, or | “Excessive thirst, excessive |
| | a set of comma- | urination, weight loss, excessive |
| | separated phrases that | hunger, extreme fatigue, lack of |
| | is a (sub)set of the | energy” |
| | correct set of phrases | and a correct answer is any subset of the |
| | | above set of 6 symptoms that contains at |
| | | least 3 symptoms, e.g., |
| | | “weight loss, excessive hunger, lack |
| | | of energy” |

Also possible is verification of student's format of type FLOAT (such as 4 above), and also of type STRING of characters (such as 4/9 above). For example, the answers 4/9, 12/27 or 24/54 represents the same FLOAT number, however only 4/9 is the correct answer to problem 2 above.

Relationship of Textbook/Problem Data Structures with the Student's Current Class and Position within the Current Class

A student may be working on several classes by communication with the server-side system 100. At each moment, the student can only work on one class, this class is called currently Active Class for the student. If the student switches to work on a different class, her/his position in the previously active class is remembered by the server-side system 100. In that way, once the student switches back, (s)he can continue to work on the same problem as before the switch. The student's position in each of her/his classes is stored in the following table 11.

TABLE 11
Student_Current_Position

| Student | School | Class | | | | |
|---|---|---|---|---|---|---|
| ID | ID | ID | Chapter | Section | Problem | CurrentClass |
| 1 | 1 | 1 | 1 | 2 | 5 | Yes |
| 2 | 1 | 1 | 4 | 1 | 7 | No |
| 2 | 1 | 2 | 2 | 1 | 3 | Yes |
| 3 | 1 | 3 | 3 | 1 | 1 | Yes |

The columns School ID and Class ID were populated from the Class_to_Student table above. For illustrative purposes, lines for student 4 and 5 in the Student_Current_Position table have been omitted. Note that Student 2 is working on two classes (Class 1 and Class 2), and that student is currently working on Class 2.

Progress Reports and Automated Homework Grading: Teacher- and Student-Generated Reports

The server-side system also allows for student progress report generating functionality and the related automated homework grading functionality. The server-side system can automatically record the number of requests made by each student to view every problem's formulation, theory excerpt, hint, solution, and answer. Additionally, the server-side system can track all the attempts to submit the answer to each problem. Because the date/time stamp of each student's request is recorded, the server-side system marks the problem “solved” by the student only if the correct answer was submitted by the student prior to viewing the solution or the answer to that problem.

Each Student can view her/his own progress report and homework grade. The Teacher can view progress/homework grades for all students in all of her/his classes.

Table 12 below indicates the progress report viewable by the student. The teacher can see the report for each student in her/his class; also the reports can be formatted in various ways (all students in a given class, all classes for a given student) and sorted in various ways (by student's last name, by students with currently best performance). Automated homework grading reports are viewable by student (for her/his own progress) and by teacher (for all of her/his students); the grade can be displayed on various scales (percentage, A-F scale). The grades calculation is carried out in accordance with the rules set by the teacher (each problem can be marked as required or bonus, various grade requirements in terms of solved problems can be selected).

TABLE 12
Student_Progress/Homework_Grades

| Student | Class | Problem | Number of Requests | | | | | Solution Status | | |
|---|---|---|---|---|---|---|---|---|---|---|
| ID | ID | ID | Formulation | Theory | Hint | Solution | Answer | Attempts | Solved | Myself |
| 1 | 1 | 1 | 1 | 0 | 1 | 0 | 0 | 1 | Yes | Yes |
| 1 | 1 | 2 | 3 | 2 | 2 | 1 | 0 | 2 | Yes | No |
| 1 | 1 | 3 | 2 | 1 | 1 | 0 | 0 | 1 | Yes | Yes |
| 1 | 1 | 4 | 0 | 0 | 0 | 0 | 0 | 2 | No | No |
| 2 | 1 | 1 | 1 | 1 | 0 | 0 | 0 | 3 | Yes | Yes |
| 2 | 1 | 2 | 0 | 0 | 0 | 0 | 0 | 0 | No | No |
| 2 | 1 | 3 | 1 | 1 | 1 | 0 | 0 | 0 | No | No |
| 2 | 1 | 4 | 0 | 0 | 0 | 0 | 0 | 0 | No | No |

The server-side system 100 can feature two types of reports. The first type displays the information from table Student_Progress above. The second type uses the column Solution Status/Solved Myself column together with the criteria chosen by the Teacher in order to facilitate automated grading of homework assignments.

The term ‘grading’ rather than ‘reporting’ is used because it is a feature of server-side system to verify the correctness of the attempted answers submitted by the students. A variety of answer formats is supported by the server side 100; see Table 10 above for several possible answer formats.

One way to define the homework grading criteria in server-side system 100 is to create a list of homework problems and calculate the ratio of solved problems to the total number of problems, and multiply by 100%. Alternatively, letter grades (A through F, say) can be assigned to certain percentage buckets.

The reporting functionality in server-side system 100 over the input channels (SMS, Email, Website) can be implemented as follows. A Student can request a progress report in brief format via the SMS channel. In that case, the system reply includes only the information on the Solution Status/Solved Myself column (see command “R” in Table 14 below). As discussed below, detailed progress reports and homework grade status can be viewed in detailed format when the Student accesses server-side system 100 via email or signs in to the system website.

Monitoring the Student Progress Reports/Automated Homework Grading at the Website

As explained above, the Student can view the parts of the Student_Progress/Homework_Grades table corresponding to her/his own Student ID after signing in to the server-side system 100 website gamelike.net. The Teacher can view the parts of the Student_Progress/Homework_Grades table that correspond to Class ID for each of her/his class after signing in to the server-side system' website. As mentioned above, the reports can be sorted and presented in various ways.

Automated Student Progress/Automated Homework Grading Reports in Excel™ Format

In order to request a report via email, the Student or the Teacher sends an empty email to reports@gamelike.net indicating in the subject line the class(es) for which the report is requested. If nothing is given in the subject one, the set of reports for all of your classes will be sent. Server-side system 100 automatically creates an Excel™ file that contains appropriate information from the Student_Progress/Homework_Grades table and sends that file as an attachment to the automatically generated email in return to the email request from the student/teacher.

List of Server-Side System Commands for SMS, Email, and Web Dialogs: Processing Algorithm for Each Command—Communication Channels: Access Details

The same commands can be used for all of communication channels. The access details can be described as shown in Table 13.

TABLE 13
Communication Channels: Access Details

| Channel | Access Description | Remarks |
|---|---|---|
| SMS | Send SMS starting | Once an SMS dialog is started (i.e., when replying to a |
| | with “server-side | message from server-side system 100), the word |
| | system 100” and | “server-side system 100” does not need to be included |
| | containing a | (except when sending mathematical expressions, the |
| | command or an | command ‘W’, or commands with the decimal delimiter, |
| | expression to the | e.g., W 1.2). This adds considerable convenience and |
| | short number 41411. | speed to the student-system dialog. |
| Email | Send email containing | 1. The information in the email can be placed |
| | one of the commands | anywhere in the Subject line and/or the message |
| | or an expression to | body. When replying to an automated email from |
| | the address | gtps@gamelike.net, the information can be placed |
| | gtps@gamelike.net. | anywhere before the word “Re:” in the Subject line |
| | | and/or before the copy of the message from |
| | | gtps@gamelike.net in the message body. |
| | | 2. If the user's phone allows sending/receiving email, |
| | | (s)he may choose the Email communication channel |
| | | that does not carry messaging charges for working |
| | | with server-side system 100. The mobile email does |
| | | carry data transfer charges; however, the |
| | | communication with server-side system 100 is very |
| | | light on data usage. |
| | | 3. Detailed own progress reports in Excel ™ format will |
| | | be automatically sent to the student as email |
| | | attachments after sending an email to a different |
| | | email address, reports@gamelike.net. |
| Website | Log on to | In addition, detailed own progress reports are |
| | gamelike.net, the | available to the student via the website. |
| | dialog is carried out in | |
| | the same way as via | |
| | SMS/Email. | |

One approach implemented in designing the server-side system 100 is that the user-system interaction should be uniform over the three text based communication channels. As noted above, one manifestation of this principle is that the user can seamlessly switch between the three communication channels and continue using email, say, from the place where (s)he stopped an SMS dialog. The second application of the uniform treatment principle is that the format of the commands when using the three channels is exactly the same. Note finally that the user's input is very short and fast, whereas the system generates detailed replies. For example, short student input can be as short as just one symbol, but the replies from the system (see Example 2 above for an extended student-system dialog as generated by the system) is detailed.

There are various types (e.g., four types) of commands as described below. The detailed description of the handling algorithm for each command follows. A block diagram can be created based on the algorithm descriptions below,

List of Commands

### Informational:

| | |
|---|---|
| ? | request the list of commands |
| I | request INFORMATION about the user: who am I? |
| L | request information about the textbook: |
| | LIST of chapters/sections numbers/names, number |
| | of problems in each chapter/section, total numbers |

### Reporting:

| | |
|---|---|
| R | request the user's progress REPORT: |
| | solved problems/total problems for current |
| | problem/section/chapter/class |

### Location:

| | |
|---|---|
| C | request the list of available CLASSES/set the active class to work on |
| W | request/set the current position in the active class: WHERE am I? |
| F | move FORWARD by one problem |
| B | move BACKWARD by one problem |

### Problem:

| | |
|---|---|
| P | request the statement of the PROBLEM |
| T | request the THEORY excerpt for the problem |
| H | request the HINT |
| S | request the SOLUTION |
| A | request the ANSWER |
| Expression | check whether the expression is the correct |
| | answer to the present problem |

Algorithms of the Command Handling

We note that in the course of the communication with server-side system 100, the user is identified by server-side system 100 (either by the cellular phone number for SMS, or by her/his email address, or by the authenticated user's login name). Because of that, the user's currently active class and current position within that class, the user's progress report table, and other data is available to server-side system 100 in the course of the dialog with the user. Table 14 below shows a list of commands, the types of the commands and corresponding server-side actions for commands.

TABLE 14
List of Commands and Associated Server-Side Actions

| Command | Type | server-side system 100 Action |
|---|---|---|
| ? | Informational | Send the text |
| | | Commands: Info: I, L[chap[.sect]]. |
| | | Position: C[class], F, B, W[chap[sect[prob]]]. |
| | | Problem: P, T, H, S, A, or expression. |
| | | Visit gamelike.net for details. |
| | | to the user |
| I | Informational | Obtain the user's first_name, last_name, school |
| | | affiliation from the database using her/his identity as |
| | | discussed above, and send the message |
| | | Welcome user_first_name user_last_name. |
| | | You are a user_type_string at |
| | | user_school_name. |
| | | Send C for your classes or ? for commands. |
| L [chap | Informational | Obtain the ID of the currently active class for the user |
| [.sect]] | | from the database using her/his identity. For that class: |
| | | if no argument is given, obtain the list of chapter numbers |
| | | and send the message |
| | | Current class class_name contains num_of_chapters |
| | | chapters. Send L chap with |
| | | chap=1 . . . num_of_chapters for more information. |
| | | If one argument chap is given, obtain the name of that |
| | | chapter and the number of sections in that chapter, and |
| | | send the message |
| | | Chapter chap, “chapter_name”, contains |
| | | num_of_sections sections. Send L chap.sect with |
| | | sect=1 . . . num_of_sections for more information. |
| | | If two arguments chap.sect are given, obtain the name of |
| | | that section and the number of problems in that section, |
| | | and send the message |
| | | Section chap.sect, “section_name”, contains |
| | | num_of_problems problems. Use commands F, B, W |
| | | to navigate between problems. |
| R | Reporting | Obtain the ID of the currently active class, and also the |
| | | currently active chapter, section, problem for the user |
| | | from table Student_Current_Position. In addition, obtain |
| | | the total number of problems in the currently active |
| | | section, chapter, and entire class. From the |
| | | Student_Progress table, obtain the solution status by the |
| | | student of the current problem, and all problems in the |
| | | current section, chapter, and class. Based on that data, |
| | | send the message |
| | | Progress report (solved/total): |
| | | Problem chap.sect.prob.: solved_prob/1 |
| | | Section chap.sect: solved_sect/total_sect |
| | | Chapter chap: solved_prob/total_chap |
| | | Current Class: solved_class/total_class |
| C [class] | Location | Obtain the ID of the currently active class, and also the |
| | | list of classes available to the current student from table |
| | | Class_to_student. After that |
| | | if no argument is given, send the message |
| | | Current class: class_name. To change, send C |
| | | number with number = |
| | | list_of_available_class_numbers |
| | | if the argument class is given, and that class is available |
| | | to the student, set the active class to the given class |
| | | updating the table Student_Current_Position and send |
| | | the message |
| | | Current class was set to: new_class_name. |
| | | Otherwise, do not change the current class and send the |
| | | error message |
| | | You are not registered for class number “class”. Send |
| | | C for available class numbers. |
| W [chap [.sect | Location | Obtain the ID of the currently active class, and also the |
| [.prob]]] | | currently active chapter, section, problem for the user |
| | | from table Student_Current_Position. |
| | | If no argument is given, send the message |
| | | Current location: Problem |
| | | curr_chap.curr_sect.curr_prob (Problem curr_prob in |
| | | Section curr_sect of Chapter curr_chap). |
| | | Send W chap.sect.prob, W chap.sect, W chap to |
| | | change location. Related commands: L and C. |
| | | If one argument is given, and the given chap exists in the |
| | | current class, set the current position to the first problem |
| | | in the first section of the given chapter and send the |
| | | message |
| | | Current problem is set to Problem |
| | | curr_chap.curr_sect.curr_prob. |
| | | Use commands P, T, H, S, A to work with this |
| | | problem. Use commands F, B, W to change current |
| | | problem. |
| | | Otherwise do not change the current location and send |
| | | the error message |
| | | Cannot find Chapter chap. |
| | | Send L for available chapter, section, and problem |
| | | numbers. |
| | | If two arguments are given, and the given chap and sect |
| | | exists in the current class, set the current position to the |
| | | first problem in the given section and send the message |
| | | Current problem is set to Problem |
| | | curr_chap.curr_sect.curr_prob. |
| | | Use commands P, T, H, S, A to work with this |
| | | problem. Use commands F, B, W to change current |
| | | problem. |
| | | Otherwise do not change the current location and send |
| | | the error message |
| | | Cannot find Chapter chap.sect. |
| | | Send L for available chapter, section, and problem |
| | | numbers. |
| | | If three arguments are given, and the problem number |
| | | chap.sect.prob exists in the current class, set the current |
| | | position to that problem and send the message |
| | | Current problem is set to Problem |
| | | curr_chap.curr_sect.curr_prob. |
| | | Use commands P, T, H, S, A to work with this |
| | | problem. Use commands F, B, W to change current |
| | | problem. |
| | | Otherwise do not change the current location and send |
| | | the error message |
| | | Cannot find Problem chap.sect.prob. |
| | | Send L for available chapter, section, and problem |
| | | numbers. |
| F | Location | Obtain the ID of the currently active class, and also the |
| | | currently active chapter, section, problem for the user |
| | | from table Student_Current_Position. Obtain the list of |
| | | Problem ID's for the current class ordered by Chapter, |
| | | Section, Problem from table Textbook_TOC. |
| | | If the current problem is not the last problem in the above |
| | | list, set the current problem to the next problem in the list |
| | | and send the formulation of that new problem (see |
| | | command P below) |
| | | If the current problem is the last problem in the list, do not |
| | | reset the current problem and send the error message |
| | | Current Problem curr_chap.curr_sect.curr_prob is the |
| | | last problem in the course: cannot move to the next |
| | | problem. |
| B | Location | Obtain the ID of the currently active class, and also the |
| | | currently active chapter, section, problem for the user |
| | | from table Student_Current_Position. Obtain the list of |
| | | Problem ID's for the current class ordered by Chapter, |
| | | Section, Problem from table Textbook_TOC. |
| | | If the current problem is not the first problem in the above |
| | | list, set the current problem to the previous problem in the |
| | | list and send the formulation of that new problem (see |
| | | command P below) |
| | | If the current problem is the first problem in the list, do not |
| | | reset the current problem and send the error message |
| | | Current Problem curr_chap.curr_sect.curr_prob is the |
| | | last problem in the course: cannot move to the next |
| | | problem. |
| P | Problem | Obtain the ID of the currently active class, and also the |
| | | currently active chapter, section, problem for the user |
| | | from table Student_Current_Position. Using that data, |
| | | obtain the unique Problem ID for the current problem |
| | | from table Textbook_TOC. Finally, using the Problem |
| | | ID, obtain the problem formulation from table |
| | | Problem_Info. Update the table Student_Progress by |
| | | increasing the Formulation field by one. Send the |
| | | message |
| | | Problem curr_chap.curr_sect.curr_prob. |
| | | Formulation. |
| | | Problem_formumation |
| T | Problem | Repeat the steps for the P command as above, but now |
| | | obtain the theory excerpt for the problem from table |
| | | Problem_Info, and increase the Theory field in table |
| | | Student_Progress. Send the message |
| | | Problem curr_chap.curr_sect.curr_prob. |
| | | Theory. |
| | | Problem_theory_excerpt |
| H | Problem | Repeat the steps for the P command as above, but now |
| | | obtain the hint for the problem from table Problem_Info, |
| | | and increase the Hint field in table Student_Progress. |
| | | Send the message |
| | | Problem curr_chap.curr_sect.curr_prob. |
| | | Hint. |
| | | Problem_hint |
| S | Problem | Repeat the steps for the P command as above, but now |
| | | obtain the solution for the problem from table |
| | | Problem_Info, and increase the Solution field in table |
| | | Student_Progress. Send the message |
| | | Problem curr_chap.curr_sect.curr_prob. |
| | | Solution. |
| | | Problem_solution |
| A | Problem | Repeat the steps for the P command as above, but now |
| | | obtain the answer for the problem from table |
| | | Problem_Info, and increase the Answer field in table |
| | | Student_Progress. Send the message |
| | | Problem curr_chap.curr_sect.curr_prob. |
| | | Answer. |
| | | Problem_answer |
| Expression | Problem | Obtain the ID of the currently active class, and also the |
| | | currently active chapter, section, problem for the user |
| | | from table Student_Current_Position. Using that data, |
| | | obtain the unique Problem ID for the current problem |
| | | from table Textbook_TOC. Finally, using the Problem |
| | | ID, obtain the problem_answer and |
| | | problem_answer_type from table Problem_Info. Update |
| | | the table Student_Progress by increasing the field |
| | | solution_attempts by one. Bring the user input to the |
| | | standard form (remove unnecessary spaces, |
| | | tabulations, new line characters, etc.). |
| | | If problem_answer_type is string, verify the correctness of |
| | | the user's input by direct comparsion with |
| | | problem_answer. |
| | | If problem_answer_type is expression that evaluates to |
| | | floating point number, form a string “user_input—answer” |
| | | corresponding to the difference of the attempted answer |
| | | and the correct answer, and verify that the formula in this |
| | | string evaluates to zero (see Subsection 8.8 below for |
| | | more details). |
| | | If problem_answer_type is set of strings with the correct |
| | | answer being a (sub)set of that set, using direct string |
| | | comparison verify that each of the strings in the user's |
| | | input is indeed in the correct set, and that the number of |
| | | different strings in the user's input is not smaller than the |
| | | required number of correct strings. |
| | | If the answer is correct, Update the table |
| | | Student_Progress by setting the field Solved to Yes. If |
| | | both of the Solution and Answer requests fields are |
| | | zero, set the Solved_Myself field to Yes, otherwise set |
| | | that field to No. Send the message |
| | | Well done! Your answer user_input is correct. |
| | | If the answer is not correct, send the message |
| | | Unfortunately, your answer user_input is not |
| | | correct. |

Website Design and User Privileges: Administrator, Teacher, and Student Zones—Server-Side System Login/Information Page

The following describes the login/information page of the website operated by the server-side system 100. The server-side system 100 can be implemented as a mobile-enabled platform for advancing K-12, higher education, and professional training. The server-side system 100 can enable automated dialogs between students and the system. In the course of a dialog, the student can carry out the following:
select the specific class and select the problem in the class to work on
request a problem formulation
submit an answer which is instantly verified by server-side system 100 and receive immediate automated feedback. Multiple attempts are permitted
request help in the form of a theory except or a hint for the current problem
request the solution or the answer for the current problem

The student-system dialogs can be carried out across different mobile-enabled channels, such as SMS, email, and website. The website can include a demo section, and registration can be required to use the system. When already registered as a Student, Teacher, or a School Administrator, they can Log in here: by entering

Username:

Password: Submit

Other sections of the website can include a section to Register, a section on “About Us” and Contact information.

Administration Zone

The website can also include a page for the administrators. The following describes an example of a page for the Administrators:

### Welcome, John Homewood.

You are logged in as Administrator for the Union High Culver City School in Los Angeles, Calif.
You have the authority to View/Add/Edit/Remove records for Teachers, Students, and Classes for your organization.
In addition, you can download reports that list information pertaining to Teachers, Students, and Classes from the website, or request automated email delivery of the appropriate report as an email attachment. All reports are in Excel™ format.
In order to request a report via email, send an empty email to reports@gamelike.net indicating in the subject line any of the words teachers, students, classes separated by commas. If nothing is given in the subject line, the complete set of reports will be sent.
Please follow the rules established within your organization concerning student privacy when receiving reports from server-side system via email.

### Possible Actions:

### Manage Information:

Choose the group of records

Teachers

Students

Classes

Choose the desired action

View Records/Request Report

New Records: Add Manually/Upload from File

Existing Records: Edit Manually/Update from File

Existing Records: Delete Manually

### Submit

The website can include additional pages for the administrators. The following describes another example of a web page for the Administrators:

### Welcome, John Homewood.

You are logged in as Administrator for the Union High Culver City School in Los Angeles, Calif.
You are currently working on the following group of records: Students
The chosen action is: Existing Records: Edit Manually/Update from File

### List of Students:

| | | | | | Possible Actions | |
|---|---|---|---|---|---|---|
| | Stu- | Name | Grade/ | Classes | | Class |
| | dent | (Last, First) | Group | Attended | Contact | Associ- |
| Num | ID | Sort | Sort | Sort | Info | ation |
| 1 | 1 | Anderson, | 5A | Math 5 | Edit | Edit |
| | | Laura | | | | |
| 2 | 4 | Brenner, Ed | 7C | Math 7 | Edit | Edit |
| | | | | Phys 7 | | |
| 3 | 3 | DeVico, Sarah | 7A | Chem 7 | Edit | Edit |
| 4 | 2 | Morris, Alex | 6A | Biol 6 | Edit | Edit |

### Additional Actions:

### Download the List as an Excel™ File

### Update Student Data via Text File Upload

The format of the download/upload report files is described below.

Teacher Zone

The website can include pages for the teachers. Below is an example replication of the teachers' web page.

### Game-like Teaching/Practice System

### Mobilizing Education™

### Promoting Student Participation and Self-training in an Exciting Interactive Way

### Automating Grading of Homework Assignments and Reporting of Student Progress

### Welcome, Gregg Parker.

You are logged in as Teacher for the Union High Culver City School in Los Angeles, Calif.
You have the following authorities for your organization:

View records for Students

View/Add/Edit/Remove records for Classes

View/Add/Edit/Remove associations between Students and Classes

In addition, you can download reports that list information pertaining to Teachers, Students, and Classes from the website, or request automated email delivery of the appropriate report as an email attachment. All reports are in Excel™ format.
In order to request a report via email, send an empty email to reports@gamelike.net indicating in the subject line any of the words teachers, students, classes separated by commas. If nothing is given in the subject line, the complete set of reports will be sent.
Please follow the rules established within your organization concerning student privacy when receiving reports from server-side system 100 via email.

### Possible Actions:

### Manage Information:

Choose the group of records

Students

Classes

Choose the desired action

View Records/Request Report

New Records: Add Manually/Upload from File

Existing Records: Edit Manually/Update from File

Existing Records: Delete Manually

### Submit

The website can include pages for the students. Below is an example replication of the students' web page.

### Game-like Teaching/Practice System

### Mobilizing Education™

### Promoting Student Participation and Self-training in an Exciting Interactive Way

### Automating Grading of Homework Assignments and Reporting of Student Progress

### Welcome, Ed Brenner.

You are logged in as Student for the Union High Culver City School in Los Angeles, Calif.
Using the present Game-like Teaching/Practice System (server-side system 100) you can:

Interactively solve problems for your classes (see details below)

Request detailed reports on your progress in any of your classes

You can access the system via SMS, Email, or the present website. The communication is text-message (SMS) based and does not require a smartphone or any cellular phone software download.
You can carry out the following actions:
View/Add/Edit/Remove the classes that you were registered for by your Teacher (via Website only)
Send ? to view the list of server-side system 100 commands described below (via SMS/Email/Website)
Choose the classes that presently you want to work on (via SMS/Email/Website):
   Send C to view the following three items
      class_number for the class that you are presently working on
      list of your classes with the identifier class_number for each class
   Send C class_number if you already know the class_number
For a selected class you can do the following (via SMS/Email/Website):
   View/Change your current position in the class in the format chapter.section. problem:
      Send W (as in Where am I?) to see the full number of the problem that you are currently working on (e.g., 1.3.4 for Chapter 1, Section 3, Problem 4)
      Send W chapter.section.problem to set your current position to the given problem (e.g., W 1.3.4)
      Send W chapter.section to set your current position to the first Problem in the given Section (e.g., W 1.3)
      Send W chapter to set your current position to the first Problem in first Section in the given Chapter (e.g., W 1)
      Send P to move to the previous Problem in the class
      Send N to move to the next Problem in the class
   View the class Table of Contents and names of Chapters and Sections:
      send B (as in textBook) to see the full list of Chapters and Sections
      send B chapter to see more information on the given Chapter (e.g., B 1)
      send B chapter.section to see more information on the given Chapter (e.g., B 1.3)
For the particular problem that you are presently working on, you can do the following (via SMS/Email/Website):
   View problem Formulation—send F
   Submit an Answer—send expression (e.g., 2/3 or 5*a-3*b) that you think is the correct answer
   View a relevant Theory excerpt from the textbook—send T
   View a Hint—send H
   View a Solution—send S
   View the Answer—send A
      In addition, you can download (via Website) or receive (via Email) your personalized reports that contain the following information:
class textbook information for each of the classes that you are taking (this information is also available in abridged form via the server-side system 100 command B described above):
   table of contents
   complete list of problems for each chapter/section
information pertaining to your progress for each of the classes that you are taking; for each Chapter and Section, you can view the following:
   total number of Problems
   number of Problems that you correctly solved and your success percentage rate
   detailed information on the status of your work for all of the Problems
      number of requests that you made to view the problem Formulation and the time of the first and last request
      number of attempts to solve the Problem and the time of the first and last request
      number of times you viewed Theory/Hint/Solution/Answer and the time of the first and last request
      whether or not you solved the problem before viewing its Solution or Answer
         Your reports can be either downloaded from the website, or delivered automatically as an email attachment. All reports are in Excel™ format.
         In order to request a report via email, send an empty email to reports@gamelike.net indicating in the subject line the classes that you are taking separated by commas. If nothing is given in the subject line, the set of reports for all of your classes will be sent.

### Manage Information:

Choose the desired action
Manage Information on Your Classes
   View your current classes
   Add a new class
   Remove the classes that you do not wish to work on
Work on Your Current Classes using the game-like Magic Form™
   interactively request and solve problems
   the format is completely analogous to the SMS and Email communication channels as described above
Download detailed Class/Problems information and
Download Your Personalized Progress Reports with Success Rate and other statistics
Download printable Introduction to server-side system 100 and a 1-page Get Started cheat-sheet (PDF files)

### Submit

Below is an example replication of another web page for the students.

### Game-like Teaching/Practice System

### Mobilizing Education™

### Promoting Student Participation and Self-training in an Exciting Interactive Way

### Automating Grading of Homework Assignments and Reporting of Student Progress

### Welcome, Ed Brenner.

You are logged in as Student for the Union High Culver City School in Los Angeles, Calif.

### Magic Form™ Student-System Interactive Interface

| | | | |
|---|---|---|---|
| Your Input: | H | Submit | Clear |

| | |
|---|---|
| System Reply: | Class: Math 5 |
| | Chapter 1. Arithmetic Operations |
| | Section 4. Fractional Numbers |
| | Problem 2. |
| | Formulation: Simplify: 12/27=? |
| | Hint: Write 12 and 27 as products of |
| | smaller numbers and cancel out the |
| | same numbers. |

When sending the system reply via Email and posting the system reply interactively in at the Webpage as displayed above, the system reply is more detailed (it is, in particular, longer and is enhanced with style elements such as boldface font and new paragraphs). When the system reply is received via SMS, the length is limited to 160 characters. It is a user option to receive longer SMS replies from server-side system 100 (multi-part SMS). The default server-side system 100 setting is to limit SMS to the standard size of 160 characters. Consequently, only the essential information is included in the SMS replies from the system, e.g., the reply to H in the above setting would be simply: Write 12 and 27 as products of smaller numbers and cancel out the same numbers.

The preferred formatting of the (longer) Email and Website system replies can be chosen by the Student. For example, instead of the above Verbose format, an Intermediate format can be chosen:

| | |
|---|---|
| System Reply: | Problem 1.4.2. |
| | Formulation: Simplify: 12/27=? |
| | Hint: Write 12 and 27 as products |
| | of smaller numbers and cancel out |
| | the same numbers. |

Or a brief format can be chosen (this format is exactly analogous to the SMS format):

| | |
|---|---|
| System Reply: | Write 12 and 27 as products of |
| | smaller numbers and cancel out the |
| | same numbers. |

Additional Information on Rapid Upload of Class Problems and Other Class Information from Text Files

One of the user privileges of TEACHER is to add classes associated with her/his school to server-side system 100. This can be done via the website interface: the steps involved are naming the class, inputting the class table of contents structure (numbers and names of chapters and sections), and finally, inputting each of the class problems into the system. Recall that each problem has fields Problem Formulation, Theory Excerpt, Hint, Solution, Answer, Answer_type. It is clear that inputting all of a class' problems using a web form is a very tedious process. This is why the class contents can be uploaded/updated via file upload at the server-side system 100 website. The format of the course upload file is intuitive: at the moment of upload, the class name is already created, so the upload file can have information on textbook chapters, sections, and problems. The file is a plain text file whose lines have the following format:

| | |
|---|---|
| Number | Chapter_Name |
| Number.Number | Section_Name |
| Number.Number.Number | //begin uploading the fields of a problem |
| PROBLEM | problem_statement |
| THEORY | problem_theory_excerpt |
| HINT | problem_hint |
| SOLUTION | problem_solution |
| ANSWER | problem_answer |
| TYPE | problem_answer_type //0,1,or 2; answer |
| | verification type |

Additional information and an extensive example of a course upload file is given above and in the Examples.

The Core Engine and Auxiliary Services Implementation: Technical Details.

Databases

For the server-side system 100, the databases can be implemented using various database software, such as the free MySQL software. The database manipulation commands in the system can be readily modified if a different database system such as Microsoft™ SQL Server, or Oracle™ SQL is used.

Core Request Processing Engine: Uniform Text Processing for the SMS, Email, Web Input Channels.

The functionalities for the server-side system 100 can be implemented in C++. This choice has the following advantages. First, C++ is a standard language and the source code can be compiled and built in a variety of operating systems (in particular, various physical and virtual Microsoft™ operating systems and Linux). Secondly, running the compiled code as a daemon constantly checking and processing the input directories (as described below) enables faster processing of the users requests than running code in an interpreting language such as PHP (self-referentially short for PHP: Hypertext Preprocessor, which is a server-side scripting language). In the proof-of-concept system only the informational functions of the Website (such as viewing the Textbook Table of Contents and the list of problems) are implemented in PHP. Thirdly, it is straightforward to run a number of copies of the code in parallel on a multi-processor server (randomization of the user request placement in the different input directories is required, see below).

An input queue directory can be implemented for each of the communication channels, SMS_in, Email_in, Web_in, where the users' inputs are stored as text files. Each file's name contains the user's unique ID. The server-side system 100 can constantly run a loop as follows:

While(1)
{

Process_SMS_queue( );
Process_Email_queue( );
Process_Web_queue( );

}

In addition, the server-side system 100 can look up the files in the directories, process them one-by-one, delete the input files, and store the output as a text file in one of the output queue directories, SMS_out, Email_out, Web_out. After that, the output file can be picked up by the script that placed the corresponding input file, forwarded to the user, and deleted.

Request and Replay Queue Management

In one aspect, of the system, the Request and Reply queues are implemented as channel-specific directories where the requests/replies are stored as text files. These text files are deleted after each communication transaction (receive request-process request-send reply) is complete. For system maintenance and reporting purposes, each pair request/reply is stored in a dedicated table in the server-side system 100 database. That database record contains the unique user identifier, the communication channel, the date/time stamp for request and reply, and the user's currently active course, chapter, section, problem. While processing each request, the server-side system 100 creates a log of eventual processing errors (e.g., in case a MySQL database error occurred) with internal codes that simplify server-side system 100 troubleshooting. That log is also stored with each reply/request record.

Further details on the Request and Reply queue handling are provided below.

As noted above, the multi-threaded production version of the server-side system 100 involved a large number of server-side system 100 processes running in parallel whereas the user requests received via the three channels are placed randomly in the large number of incoming directories (each for one copy of the server-side system 100 running process).

Database Connector Implementation

As noted above, the server-side system 100 processing engine can be implemented in C++. The MySQL database access functions are provided in the standard C++ library that comes together with the MySQL installation.

SMS Connector Implementation

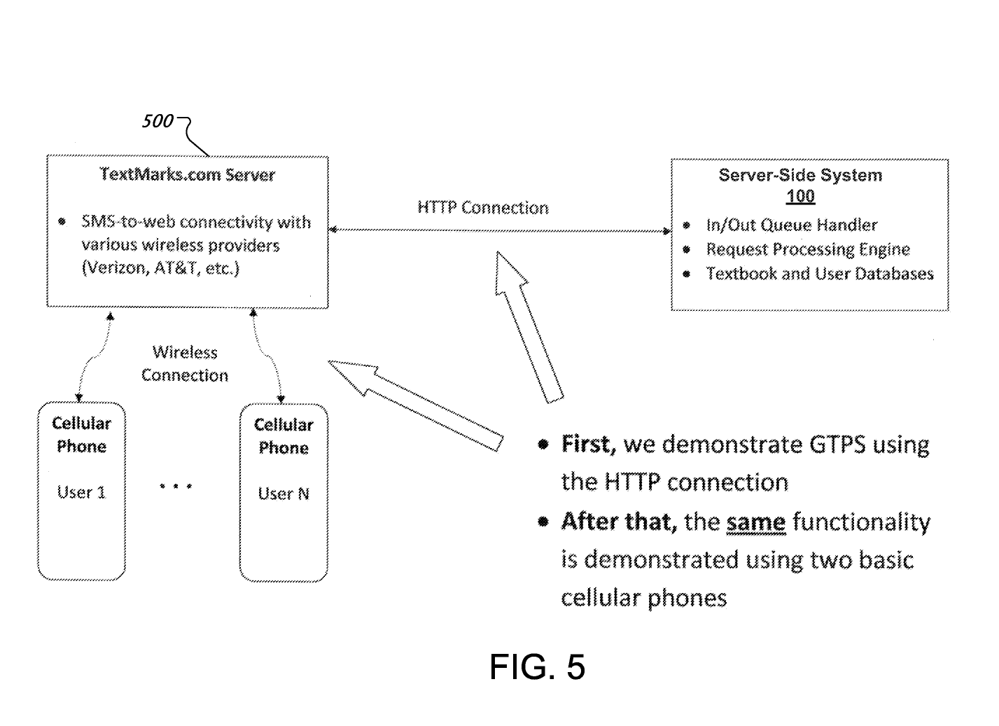

FIG. 5 shows a block diagram of implementing an SMS connector. In another aspect of the system, the connectivity between the users' cellular phones and the server-side system 100 server can be provided by an external text message forwarding system 500 (e.g., a third-party service, such as TextMarks.com service). On the technical level, the user sends a short message (SMS) to the short number (e.g., 41411) starting the message with the keyword “server-side system 100”. The message is received by the external text message forwarding system 500 and the message content together with the user's cellular phone number can be sent to the server-side system 100 server as an HTTP request. The PHP script at the server-side system writes the text request into a file in the SMS_in directory and awaits the reply from the server-side system 100 engine. The user's phone number allows server-side system 100 to identify the user when processing the request. For example, the file name can include the user's phone number and an identifier unique to the short message. The text file is then handled by the server-side system 100 processing engine and a reply is placed as a text file in the SMS_out directory. The PHP script then picks up the reply file and sends its contents back to the TextMarks.com server again via HTTP. Finally, the TextMarks.com server forwards the reply to the user as an SMS.

Email Connector Implementation

A C++ library for email server handling (e.g., SEE4C from MarshallSoft of Huntsville, Ala.) can be used to implant the Email connector. This library allows easy email processing incorporation into the server-side system 100 processing engine that is also implemented in C++. A user send her/his request to email address gtps@gamelike.net; the server-side system 100 email handling engine constantly scans the email inbox associated with the above email address; in the course of each scan all of the new messages are saved as text files into the directory Email_in. The user's email address allows server-side system 100 to identify the user. The server-side system 100 engine processes the text files in that directory and places the replies into the directory Email_out. The server-side system 100 email handling engine picks up the replies and sends them to the respective users.

Web Connector Implementation

The processing of requests submitted by the users at the server-side system's website can be similar to the SMS and Email processing. At the user input submission page, the user is signed in to server-side system 100, which allows server-side system 100 processing engine to identify the user's identity. The user input submitted via the MagicForm™ interface is placed into the directory Web_in as a text file by a PHP script which then awaits the reply from server-side system 100 as a text file in directory Web_out. The file name again contains the user's login name and a unique message identifier. Server-side system 100 constantly scans the directory Web_in and processes the set of new files read by each scan. The replies are placed in the Web_out directory where they are picked up by the PHP script and displayed at the website window where the user submitted their input.

Verifying Correctness of Student's Answer: Floating Point Mode, String of Characters Mode, (Sub)Set of Phrases of the Answer Set

As noted above, the server-side system 100 can support multiple types of answer verification. The String of Characters mode (AnswerType=1) is the simplest: the user's input is brought to standard form (new line and tabulation characters are replaced with spaces, multiple spaces are removed) and compared to the answer string. (Capitalization may be ignored depending on the teacher's choice).

In the (Sub)set of Phrases verification mode (AnswerType=2), the answer consists of a set of tokens (phrases). The attempted answer tokens (phrases that were separated by commas, say) are extracted from the user input. After that each token is searched for in the answer set of tokens. For the user input to be deemed correct, two conditions must be met: each of the user tokens is in fact in the correct answer set of tokens, and the number of tokens in the user input is at least the prescribed by the teacher value (e.g., 3 syndromes out of 5 must be listed).

In the Floating Point mode answer verification (AnswerType=0), the correct answer is stored in server-side system 100 as a string of characters. The verification of user's input is however carried out in the mathematical formula evaluation mode. More precisely, the new string of characters is formed in the following way:

String_to_Evaluate=User_input_string
joined by the string “-”
joined by the correct answer string.

The resulting string is then evaluated as a mathematical expression by a mathematical expression parsing software incorporated into the server-side system 100. In the server-side system 100, an Open Source Initiative mathematical expression evaluation software muParser can be used. This software is included into the C++ code of the server-side system 100 engine which is permitted by the Open Source license provided an acknowledgment is included.

In the Floating Point Mode answer verification mode, the correct answer can be either a floating point number, e.g., 4.0, or a formula that includes variables, e.g.,

Correct_answer_string=“R1*R2/(R1+R2)”.

Consequently, String_to_Evaluate above can include variables. It is a complicated and computer resource consuming problem to simplify a formula that includes variables as a symbolic expression. This problem is of course successfully addressed by the computer algebra systems such as Maple™ or Mathematica™ For example, assume that

User_input_string=“1/(1/R1+1/R2)”.

In that case,

String_to_Evaluate=“1/(1/R1+1/R2)−R1*R2/(R1+R2)”

which can be simplified symbolically to the string “0” by a computer algebra software. This would imply that the user input is a correct answer to the current problem.

However the resources required for the symbolic simplification would overwhelm the server-side system 100 server at times when many user requests are coming in. In order to ease the load on the server-side processing engine, the numerical verification of expressions involving variables can be implemented. This method tests the hypothesis that the user answer is correct and with high probability identifies the correct answer as correct, and incorrect answer as incorrect. In the above example, the mathematical expression parsing software recognizes two variables, R1 and R2, in the line String_to_Evaluate. After that, the server-side system 100 engine assigns random values to the variables R1 and R2 and evaluates the resulting expression numerically. If the resulting number is sufficiently small (smaller than 1E⁻⁶ say), server-side system 100 treats the result as being evaluated to zero, and the evaluation of the expression is repeated several more times (the number of times is proportional to the number of variables, say, twice that number). Otherwise, the answer in User_input_string is deemed incorrect. If all of the randomized attempts give a number deemed to be zero, the answer is deemed correct.

Instant Messaging/Chat Functionality

The text based architecture of the server-side system 100 readily allows for inclusion of other mobile-enabled communication channels such as Instant Messaging and Chat.

Incorporating Images as Part of SMS/Email/Web (Image Out-Text In)

Problem statements, theory excerpts, hints, and solutions to problems in many educational subjects can benefit from adding images. The most obvious example is a class in Geometry. The functionality of sending images as email attachments can be implemented and the images can be displayed in the course of the educational dialogs at the server-side system 100 website. Images can also be sent to certain cellular phones that support the Multi-Media Service (MMS) standard. The Student input to messages that include images is still text based.

Educational Competitions Enabled by the Server-Side System 100: Team and Individual Modes; Educational Tournaments Via the SMS/Email/Website Channels

In order to capitalize on the flexible architecture of the server-side system 100, and in order to further stimulate the students' desire to learn and facilitate an additional gaming element, it is possible to carry out educational tournaments between the Students/Classes/Schools subscribed to server-side system 100.

One scenario is a competition between students in the same class: a competition list of problems is loaded into server-side system 100 (e.g., in the format of a short class), and the access to that list is enabled at a given moment. After that the students request problems and try to correctly solve them competing with each other (Individual Mode) within a given time frame (e.g., 30 minutes). Note that, in one scenario, it is up to each participant to request theory excerpts and hints: there is no penalty for that except for extra time spent trying to solve a given problem.

Another possible competition mode is the Team Mode, e.g., one class in a school competes against another class. In that case, it is up to the students to separate workload: they can either try to solve different problems each, or can discuss and collaborate on a more difficult problem.

Because SMS/Email are really internationally accessible channels, once server-side system 100 is developed globally, international educational competitions can be held.

We note that server-side system 100 keeps the dated/timed records of all communication with the system in the competition mode, precisely as in the regular educational mode. That information can be accessed by the teacher/competition moderator as necessary.

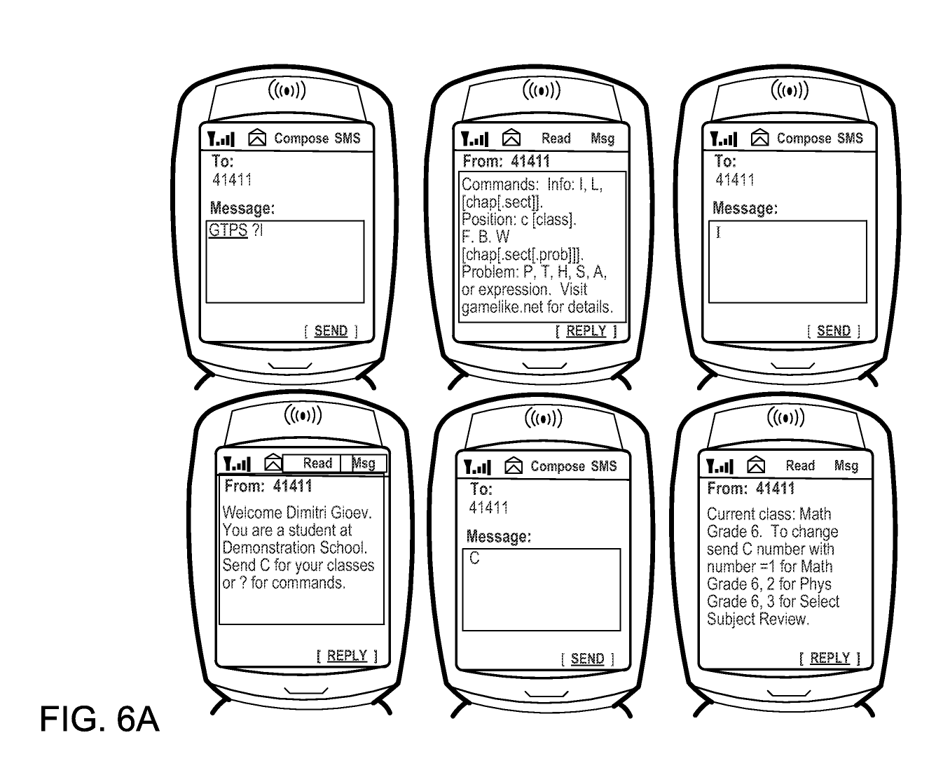

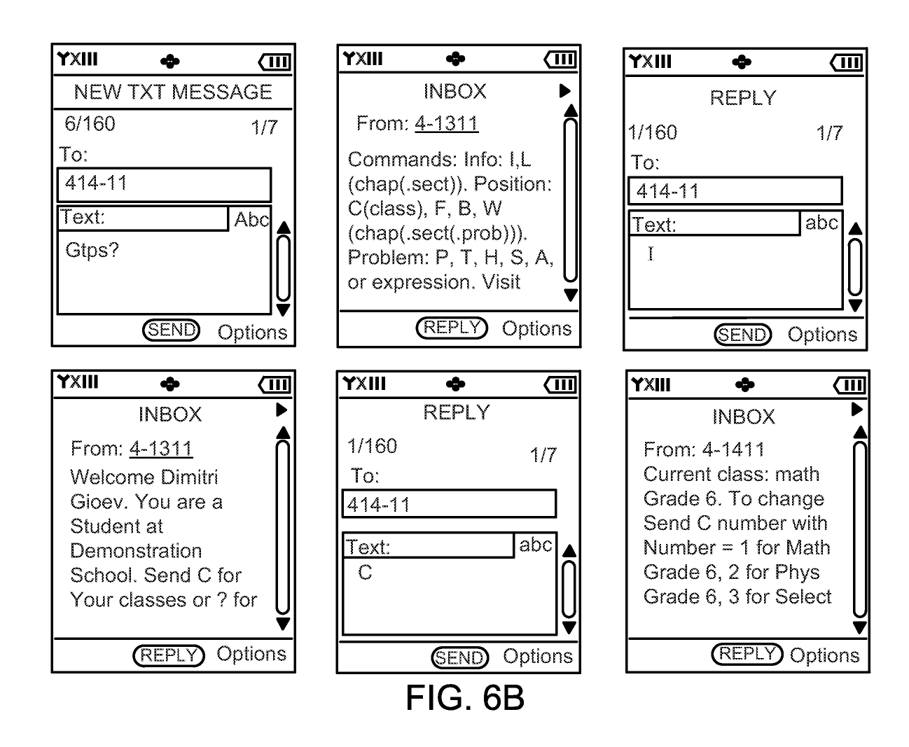

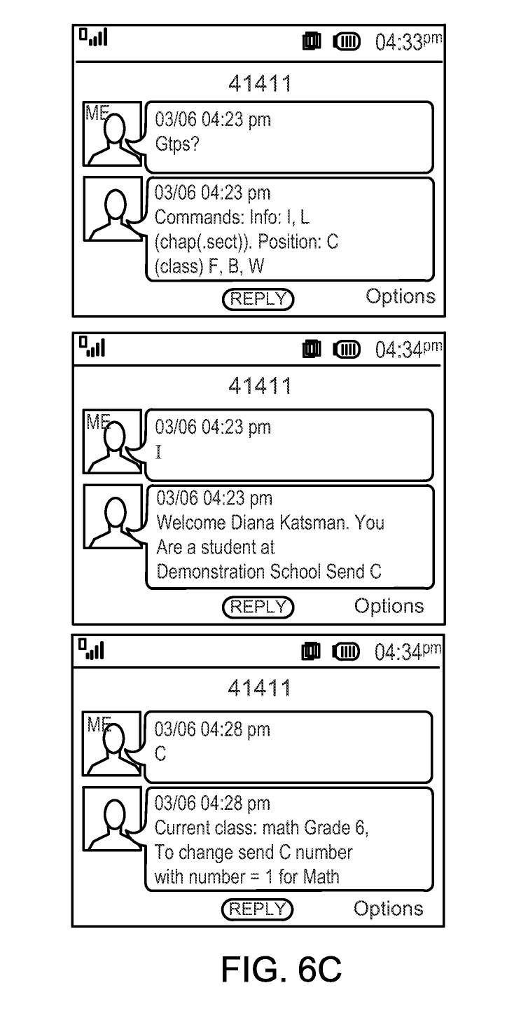

FIGS. 6A, 6B and 6C show a sequence of images that illustrate a user operating the same dialog session using two different client devices. FIGS. 6A and 6B represent a dialog using one client device (with the dialog session starting from the top row and moving across each row from left to right in each of FIGS. 6A and 6B). FIG. 6C represents the same dialog using a different client device.

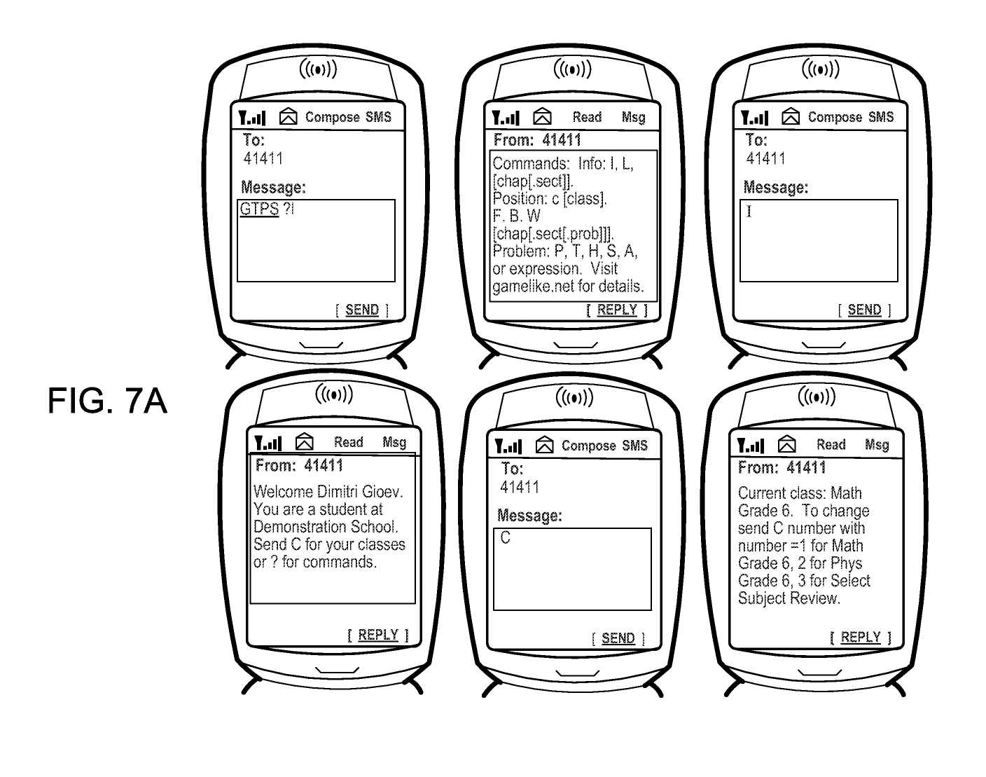

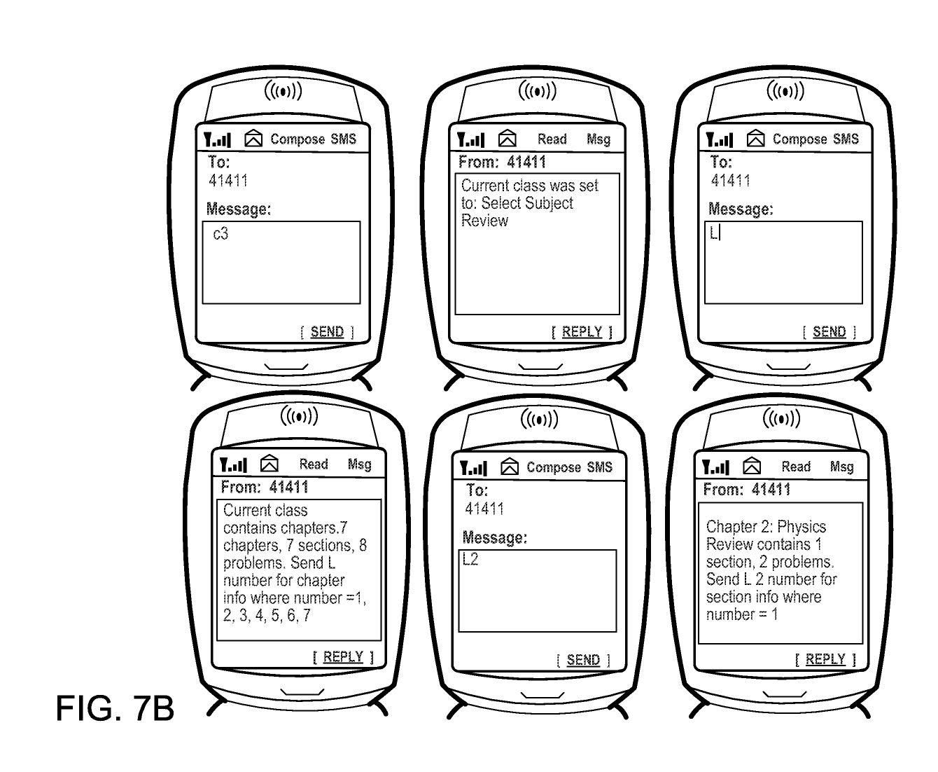

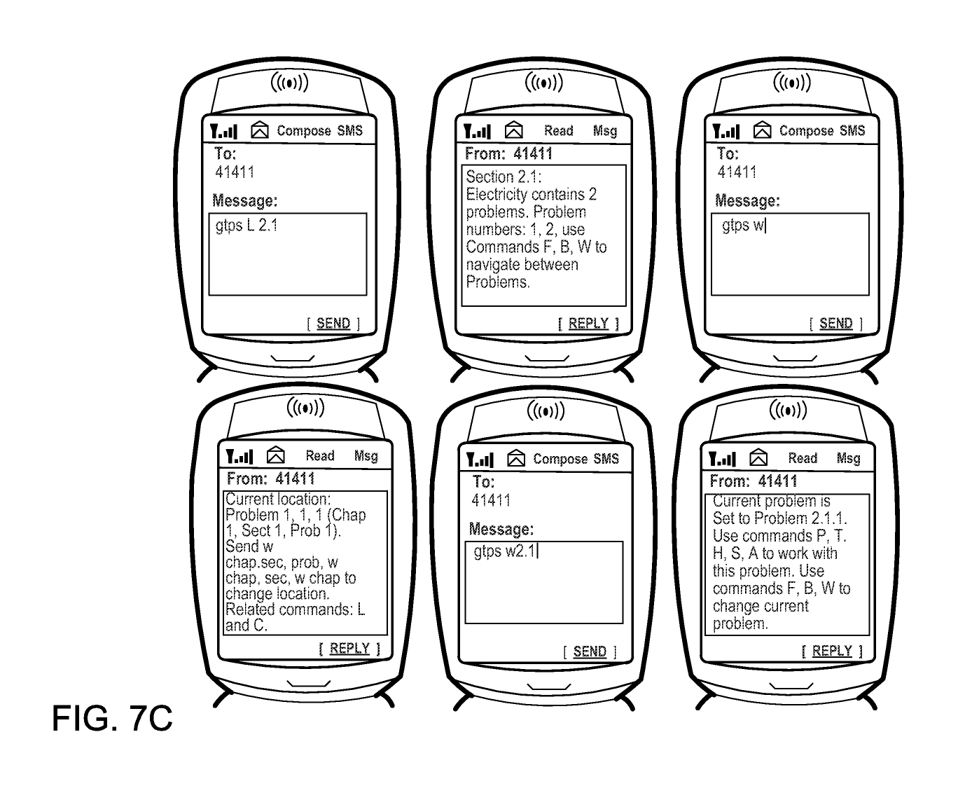

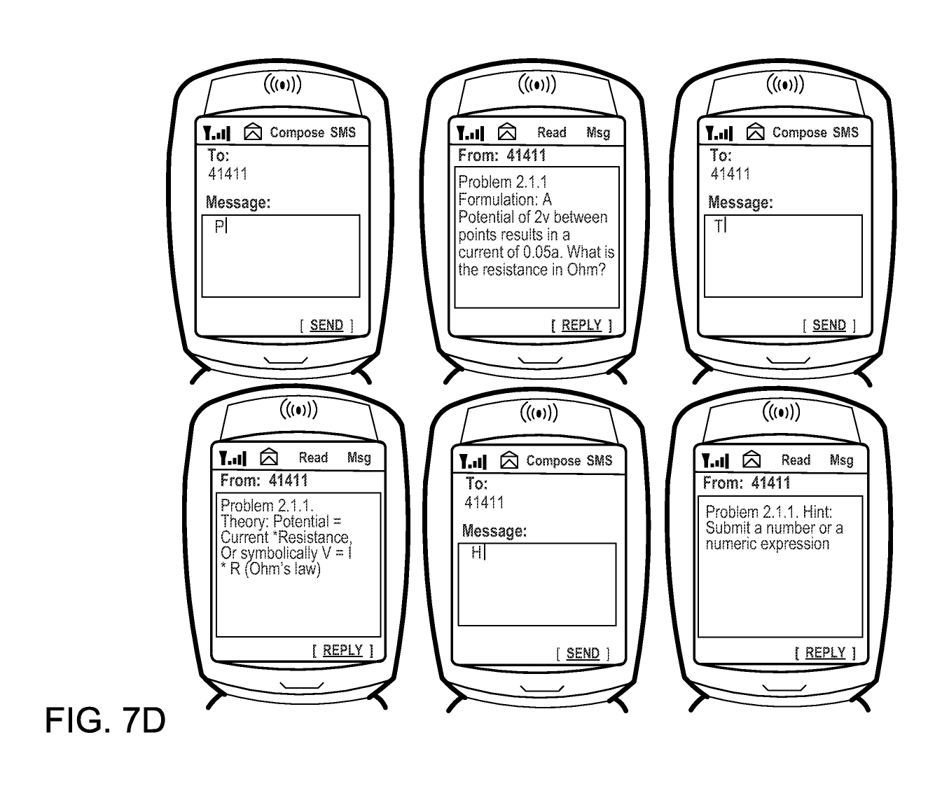

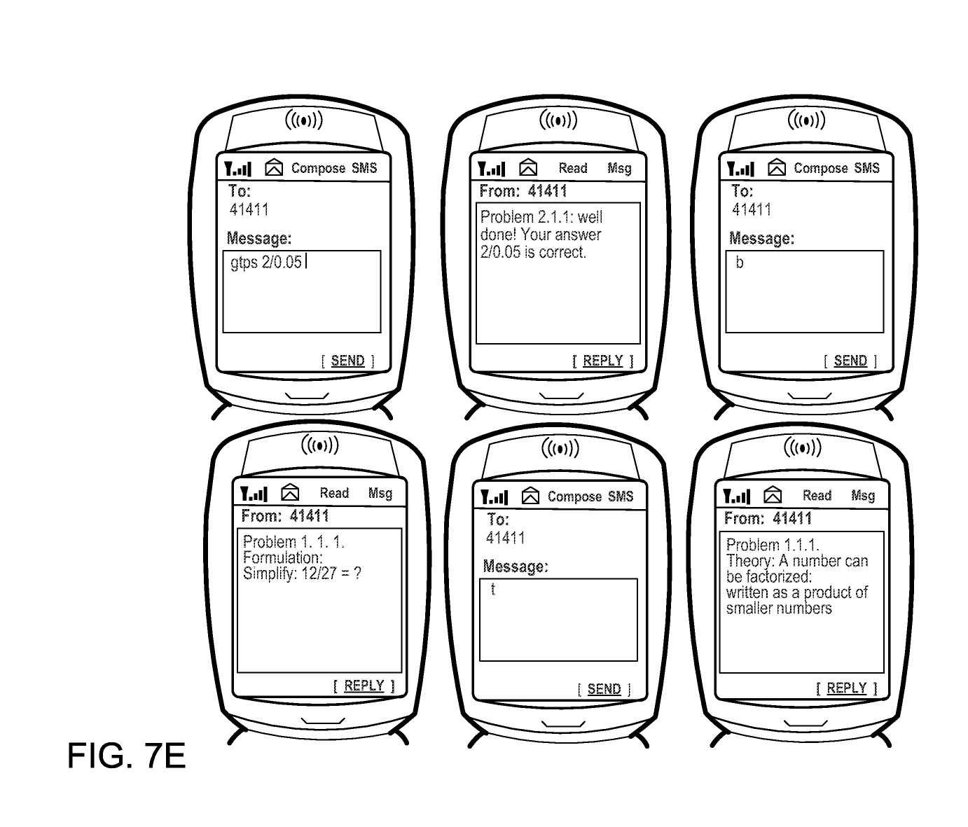

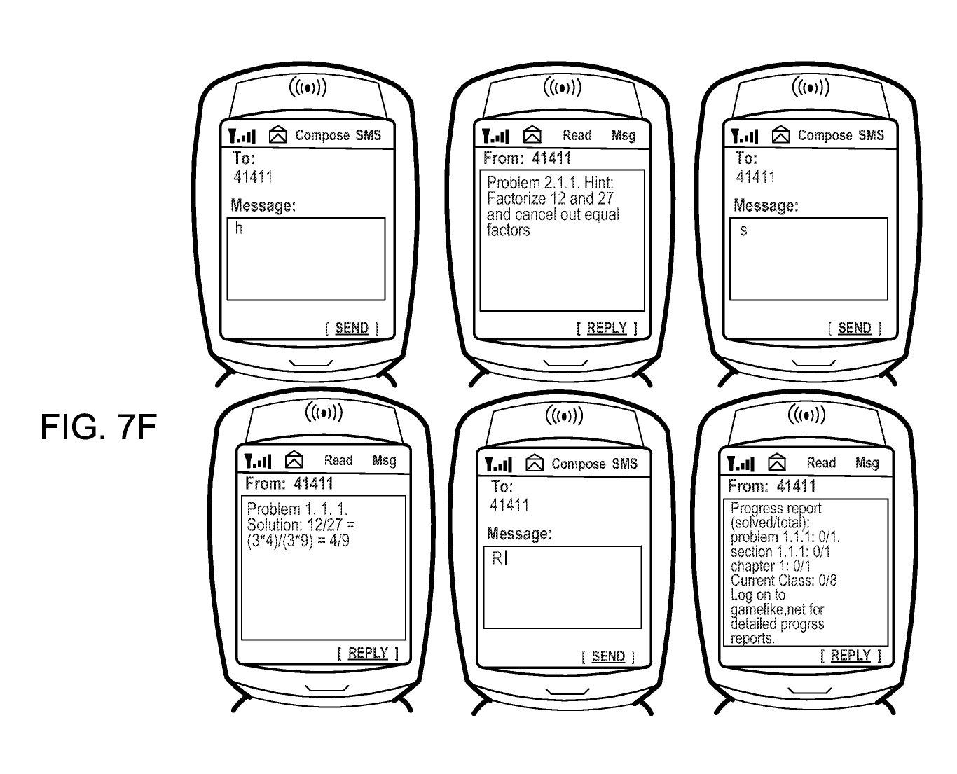

FIGS. 7A, 7A, 7B, 7C, 7D, 7E and 7F show a sequence of images that illustrate various operations and functions available to a user during a dialog session. The dialog session starts from the top row and move across each row from left to right. See Example 2 above for further details regarding the dialog session of FIGS. 7A, 7A, 7B, 7C, 7D, 7E and 7F.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices. The processor and the memory can be supplemented by, or incorporated in, special purpose logic circuitry.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results, in certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this application.

What is claimed is:

1. A method performed by a server device, the method comprising:
receiving, at the server device, a request to initiate a text-based dialog session from a user operating at a client device;
authenticating the user;
receiving a text-based message from the user requesting a response from the server device;
sending a reply text-based message to the user, wherein contents of the reply text-based message is obtained based on a context of the text-based message from the user.

2. The method of claim 1, comprising:
identifying the context of the text-based message as a request for one of information, a report, location of the user in the dialog session or a problem related to an educational lesson.

3. The method of claim 1, wherein sending a reply text-based message to the user comprises:
distributing knowledge in one or more small chunks.

4. The method of claim 3, wherein contents of the one or more small chunks include class theory and practice or problems associated with an educational lesson; and
for each practice or problem, making available at least one of associated specific theory, hint, solution or answer chunks.

5. The method of claim 3, wherein distributing knowledge in one or more small chunks comprises sending data to the user one text-based message at a time.

6. The method of claim 1, wherein the text-based message from the user comprises:
a single symbol.

7. The method of claim 1, comprising:
using a communication channel to exchange text based messages with the user, wherein the communication channel comprises at least one of:
a text messaging channel;
a Short Message Service (SMS) channel;
an automated email channel;
a text input from a website operated by the server device;
an instant messaging (IM) channel; or
a chat channel.

8. The method of claim 7, wherein using a communication channel to exchange text based messages with the user comprises:
receiving multiple text based messages from the same user, wherein each text based message from the same user is received through different communication channels during the same dialog session.

9. The method of claim 8, wherein each subsequent text based message from the same user starts from the same location in the dialog session that a previous text based message left off.

10. The method of claim 1, further comprising:
providing remote database access using short mobile-enabled commands.

11. The method of claim 2, comprising:
identifying the context of the text based message from the user as requesting a progress report for the user;
tracking a session history for the user;
generating the progress report for the user based on the session history;
formatting the generated progress report based on user input; and
delivering the formatted progress report to the user.

12. The method of claim 11, wherein the session history includes information associated with each request from the user and data requested by the user for each request.

13. The method of claim 7, further comprising:
exchanging data with the user through a voice channel.

14. The method of claim 7, wherein the text based message from the user requesting an image included with the text based message delivered by the server device and the subsequent reply text based message from the user.

15. The method of claim 1, further comprising:
wherein the text based message from the user is received at a rate controlled by the user.

16. The method of claim 15, further comprising:
sending the reply text based message from the server device responsive to receiving the text-based message from the user.

17. The method of claim 1, further comprising:
exchanging text based messages with multiple users to operate a competition among the users.

18. The method of claim 1, further comprising:
exchanging text based messaged with multiple users in a collaborative session.

19. An apparatus configured to perform the method of claim 1.

20. A system configured and arranged to perform the method of claim 1.

21. A non-transitory computer-readable medium, embodying instructions that cause at least one data processing device to perform the method of claim 1.
